(19) United States
(12) Patent Application Publication
(10) Pub. No.: US 2016/0190707 A1
(43) Pub. Date: Jun. 30, 2016

(54) ANTENNA STRUCTURE BASED ON MILLIMETER WAVE AND OPERATION METHOD THEREOF

(71) Applicant: Electronics and Telecommunications Research Institute, Daejeon (KR)

(72) Inventors: Soon Gi PARK, Daejeon (KR); Yong Seouk CHOI, Daejeon (KR)

(21) Appl. No.: 14/963,395

(22) Filed: Dec. 9, 2015

(30) Foreign Application Priority Data
Dec. 29, 2014 (KR) 10-2014-0192614
Dec. 29, 2014 (KR) 10-2014-0192615
Apr. 3, 2015 (KR) 10-2015-0047193
Apr. 3, 2015 (KR) 10-2015-0047194

(51) Int. Cl. H01Q 21/06; H01Q 3/24; H04W 36/30; H04B 7/06; H04W 36/00; H04W 36/08; H01Q 9/04; H01Q 25/00

(52) U.S. Cl. CPC H01Q 21/065; H01Q 9/0407; H01Q 3/24; H01Q 25/00; H04B 7/0617; H04W 36/0016; H04W 36/08; H04W 36/30

(57) ABSTRACT

Provided is an antenna structure of a base station, comprising: at least one beamforming disposed to include an effective beam area having a first diameter and a non-overlapping beam area having a second diameter as a projection criterion of a bottom surface at a spot beam center of a spot beamby considering characteristics, performance, a base station coverage, and a height of the beamforming antenna and disposed so that the second diameter is smaller than the first diameter by a designated size. Accordingly, an enhanced communication based on a millimeter wave is provided.

### CROSS-REFERENCE TO RELATED APPLICATIONS

This application claims priority to and the benefit of Korean Patent Application No. 10-2014-0192614 filed in the Korean Intellectual Property Office on Dec. 29, 2014, No. 10-2014-0192615 filed in the Korean Intellectual Property Office on Dec. 29, 2014, No. 10-2015-0047193 filed in the Korean Intellectual Property Office on Apr. 3, 2015 and No. 10-2015-0047194 filed in the Korean Intellectual Property Office on Apr. 3, 2015 the entire contents of which are incorporated herein by reference.

### TECHNICAL FIELD

The present invention relates to a technology associated with design and operation of a cell mobile communication system using a millimeter wave.

### BACKGROUND ART

In a mobile communication system, as a method for preparing for heavy increase in mobile traffic, three methods are generally currently proposed. A first method is to increase spectrum efficiency of a frequency, a second method is to further increase a use frequency, and a third method is to densify small cells. In the case of the second method, since below 6 GHz (B6) which is a frequency to be used as the existing cellular frequency is short, development of a new technology for using a high-frequency band not used for mobile communication (above 6 GHz (A6), in particular, a band defined by mmWave) in the mobile communication system is required. However, design and implementation of a cellular system using the millimeter wave may be very challenging in five viewpoints described below.

First, in a viewpoint of “reaching distance and linear communication”, communication is performed only in LOS because path loss increases in proportion to the square of the frequency at a higher frequency, and as a result, the reaching distance is short and linearity is strong.

Second, in a viewpoint of “shadowing”, since the millimeter wave is sensitive to shadowing, when the millimeter wave meets an obstacle (e.g., bricks) once, very large signal attenuation can occur and fading may occur due to humidity and rain.

Third, in a viewpoint of “rapid channel variation and frequent connection severance”, when a terminal moves, a channel coherence time decreases with the higher frequency (for example, when the terminal moves, Doppler spread relatively increases and a channel varies per usec as compared with the cellular frequency) and when the obstacle is generated, the path loss may show rapid swing. Consequently, such a phenomenon has a problem in that connection is increasingly abruptly stopped and rapid adaptation to a situation in which a communication environment suddenly stops is required from the viewpoint of the system.

Fourth, in a viewpoint of “multi-user adjustment”, the existing millimeter wave is used for not access but backhaul to be controlled by users of the number limited by p-to-p transmission or an MAC protocol constraining multi simultaneous transmission. Unlike this, in order for the millimeter wave to be used as an access link, a new mechanism considering simultaneous transmission on several links which interfere with each other is required.

Fifth, in terms of processing power consumption, power consumption in A/D conversion of an antenna needs to be considered and how lower-power low-cost element can be manufactured can be a key point in terms of commercialization.

Among the aforementioned viewpoints, in terms of “reaching distance and linear communication” and “shadowing”, the path loss increases with the higher frequency, but when an antenna gain is increased through a beamforming technology and the linear communication is induced through beam steering using an RF antenna assembly technology, it is possible to comes close to free space loss of a frequency actually used in the existing cellular system. In this case, a positive result (the millimeter wave may be used in an access network) to take an effect that shadowing disappears through reflection by a medium under an urban environment is presented, but there are still a lot of obstructive factors for using the millimeter wave for the access link practically.

### SUMMARY OF THE INVENTION

The present invention has been made in an effort to provide contents regarding design of an entire antenna structure of a base station and an antenna structure of a terminal in a cellular mobile communication system using millimeter waves and a simple system operating method therebetween.

An exemplary embodiment of the present invention provides an antenna structure of a base station, comprising: at least one beamforming disposed to include an effective beam area having a first diameter and a non-overlapping beam area having a second diameter as a projection criterion of a bottom surface at a spot beam center of a spot beamby considering characteristics, performance, a base station coverage, and a height of the beamforming antenna and disposed so that the second diameter is smaller than the first diameter by a designated size.

The non-overlapping beam area may include an arc-shaped projection beam center circle which coincides with an arc center of the second diameter and the center of a base station antenna and a projection beam center circle having a width equivalent to a half the diameter of the non-overlapping beam area.

An average effective projection beam area of the first diameter by the plurality of beamforming antennas and an average non-overlapping projection beam area of the second diameter by the plurality of beamforming antennas may be formed.

The beamforming antennas may be designed to mechanically vertically or horizontally tilt the average effective projection beam area oriented through a base station phase reference beam center orientation angle and a base station phase reference beam width or designed to be beam-tilted through beam steering using electronic phase control.

Spot beams of the beamforming antennas may be beam-tilted so as to guarantee the average non-overlapping beam area with a designated size or more.

The beamforming antennas may separate a plurality of beam component carriers defined by dividing a millimeter wave wideband into predetermined-unit frequencies into a plurality of groups and be disposed so that beams overlap with each other.

Beamforming antennas that take charge of one partition among the beamforming antennas divided into the plurality of groups may be disposed by considering only a substantial projected effective beam area and in areas which the projected effective beam area is not capable of taking charge of, beamforming antennas that take charge of other partitions of the frequency may be disposed to overlap with each other in an interleaving form.

The beamforming antenna may include at least one of a patch array antenna and a horn antenna.

The beamforming antennas may support a macro cell function based on a grouped sector beam structure and serve as a small cell based on a spot beam structure.

Another exemplary embodiment of the present invention provides an antenna structure of a terminal, comprising: a plurality of patch array antennas grouped by a plurality of terminal phases, wherein the plurality of patch array antennas is disposed on each of an upper end, a middle end, and a lower end.

The patch array antennas may be disposed to cover the circumference of a body surface along an actual body surface of the terminal.

The antenna structure may further include patch array antennas disposed on the top of the upper end and the bottom of the lower end, respectively.

In the patch array antennas, patch array antennas of the same number may be disposed on each of the upper end, the middle end, the lower end in a plurality of directions.

Yet another exemplary embodiment of the present invention provides an operation method of a terminal in which a plurality of patch array antennas is disposed on each of an upper end, a middle end, and a lower end, comprising: an operation of measuring cell reference signals from a plurality of terminal phase ports corresponding to the patch array antennas, respectively and memorizing a port having a signal strength of a designated magnitude or more; an operation of calculating average values of receiving ports corresponding to a designated signal level by considering the number of ports which is able to be soft-combined according to hardware performance and receiving ports corresponding to a signal levels or calculating the most excellent value among soft-combined signal receiving values; and an operation of determining a link port to correspond to the calculation result.

The method may further include: a beam tracking operation comprising at least one of an operation of determining an uplink port through cell reference signal measurement for each port and an operation of performing movement among beam groups defined as cells by using combining and an average cell reference signal measurement value.

The operation of determining the uplink port may include an operation of acquiring a cell reference signal receiving measurement value calculated to perform inter-cell handover and an operation of determining a port having a largest cell reference signal receiving measurement value for each port as a port for uplink transmission.

The beam tracking operation may include at least one of an operation of performing beam tracking in the same beam area, an operation of performing the beam tracking on a beam boundary formed by two beamforming antennas adjacent to the same base station, and an operation of performing the beam tracking on a boundary region of beams of two respective base stations.

The operation of performing the beam tracking on the beam boundary may include an operation of selecting several ports in the order in which the cell reference signal measurement value is the larger and an operation of finding several beam reference signal measurement values input at a signal level which is able to be accepted again for each port at the selected port and selecting a port in which the largest beam reference signal measurement value is input as an uplink port.

The operation of performing the beam tracking on the beam boundary may include an operation of determining multiple ports through the cell reference signal measurement value and determining an optimal port through beam signal reference signal measurement at the port again.

The determining operation may include an operation of determining the optimal uplink beam port by the premeasured multiple beam reference signal measurements having the same cell for each effective port of the determined cell.

The operation method may further include an operation of receiving base station system information comprising neighboring beam information for each beam and beam reference signal information for each cell in association with idle beam tracking.

In an antenna structure of a base station using a millimeter wave according to an exemplary embodiment of the present invention, a service area of the base station may be vertically/horizontally partitioned into multiple small-scale areas and one (or more) beamforming antenna may take charge of the small-scale areas. Therefore, the base station includes multiple beamforming antennas for taking charging of the partitioned small-scale areas and each beamforming antenna may generate a spot beam or a sector beam and one beam uses a wideband (e.g., 1 GHz) of the millimeter wave and the wideband is operated while being partitioned into subbands (e.g., 125 MHz) and we define the partition as beam component carriers and consequently, a cell is constituted in one subband or by considering the relationship between the subbands by using the BCCs as a unit.

In the antenna structure of the base station, multiple beamforming antennas for generating multiple spot beams for taking charge of base station service coverage are mounted, the beamforming antennas uses a wideband frequency, and the wideband frequency is operated while being partitioned into multiple subbands (beam component carrier).

All beam component carriers formed by multiple beamforming antennas are configured to be operated with respect to a plurality of beam component carriers corresponding to the same frequency subband (hereinafter, referred to as layer).

Still yet another exemplary embodiment of the present invention provides an antenna structure of a base station using a millimeter wave, comprising: a plurality of beamforming antennas, wherein the plurality of beamforming antennas is formed by at least one layer comprising at least one of a spot beam structure and a sector beam structure based on at least one beam component carrier acquired by dividing a wideband of the millimeter wave into layers having a predetermined size.

The plurality of beamforming antennas may be configured to operate a predetermined number of grouped beam component carriers for each layer as each cell or operate all beam component carriers of one layer as one cell.

The plurality of beamforming antennas may be configured to operate different numbers of cells for each layer.

The plurality of beamforming antennas may be configured to operate cells grouped by different numbers of beam component carrier cells for each layer.

The plurality of beamforming antennas may be configured to operate beam component carrier cells at different locations for each layer.

The plurality of beamforming antennas may be configured to operate a beamforming structure of a specific layer differently from a beamforming structure of another layer.

The plurality of beamforming antennas may be configured to operate at least one layer as a coverage layer and operate at least one residual layer as a capacitor layer.

The plurality of beamforming antennas may be configured to operate at least one active cell and at least one mute cell for each layer.

The plurality of beamforming antennas may be configured to turn off an entire layer or some cells of the layer without operation of the terminal under a designated condition and turn on the turned off layer or turns on the some turned off cells in the layer again when a data capacity is generated.

Still yet another exemplary embodiment of the present invention provides an operation method of a base station using a millimeter wave, comprising: an operation of forming at least one of a spot beam structure and a sector beam structure in a multi-layer form based on at least one beam component carrier by using a plurality of beamforming antennas; and an operation of supporting a coverage function of at least one terminal based on cells of a specific layer and supporting a capacity function of the terminal based on cells of residual layers.

According to exemplary embodiments of the present invention, beam and cell planning of a base station and a function and an operation of a terminal in such a state are defined through antenna structure design of the base station and design and operation of an antenna of the terminal to support millimeter waves to be used as an access link like a cellular system.

A possibility of connection severance can be reduced due to coverage and rapid severance of the millimeter waves, a beam boundary location, or beam switching by using a multi-layer dynamic cell provided through a method that constitutes beamforming antennas using the millimeter waves as one cell and constitutes multiple cells for each frequency assignment (FA).

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating an array RF assembly according to an exemplary embodiment of the present invention.

FIG. 2 is a diagram illustrating a beam pattern according to an array of an RF antenna assembly according to the present invention.

FIG. 3 is a diagram illustrating a method for constituting a base station antenna using multiple beamforming antennas.

FIG. 4 is a diagram illustrating a projection beam center circle for each BPH according to an exemplary embodiment of the present invention.

FIG. 5 is a diagram illustrating a beamforming antenna based base station coverage according to an exemplary embodiment of the present invention.

FIG. 6 is a diagram illustrating one example of an entire antenna structure of a base station according to an exemplary embodiment of the present invention.

FIG. 7 is a diagram illustrating one example of beam planning using effective divided projection beam areas according to an exemplary embodiment of the present invention.

FIG. 8 is a diagram illustrating an example considering mechanical tilting of a beamforming antenna according to an exemplary embodiment of the present invention.

FIG. 9 is a diagram illustrating one example of a plurality of sector beam forming beamforming antenna according to an exemplary embodiment of the present invention.

FIG. 10 is a diagram illustrating a reference beam center circle in which a center of a sector beam is projected according to the exemplary embodiment of the present invention.

FIG. 11 is a diagram illustrating one example of an antenna structure of a terminal according to the exemplary embodiment of the present invention.

FIG. 12 is a diagram illustrating an absolute start point and a repetition cycle for each beam according to the exemplary embodiment of the present invention.

FIG. 13 is a diagram illustrating a location of a reference signal resource element for each beam when beams 1 to 8 have different beam positions at the same absolute start time t1 and the same repetition cycle of 2 time unit.

FIG. 14 is a diagram illustrating a cell reference signal for each port according to the exemplary embodiment of the present invention.

FIG. 15 is a diagram illustrating a first beam tracking pattern according to the exemplary embodiment of the present invention.

FIG. 16 is a diagram illustrating a second beam tracking pattern according to the exemplary embodiment of the present invention.

FIG. 17 is a diagram illustrating a third beam tracking pattern according to the exemplary embodiment of the present invention.

FIG. 18 is a diagram illustrating an operation method of a system according to an exemplary embodiment of the present invention.

FIG. 19 is a diagram illustrating service coverage formed by an antenna structure of a base station using a sector beam structure.

FIG. 20 is a diagram illustrating multiple spot beams using multiple beamforming antennas.

FIG. 21 is a diagram illustrating a beam component carrier for each of multiple layers.

FIG. 22 is a diagram illustrating technology that groups and operates beam component carriers for a specific layer.

FIG. 23 illustrates a method for configuring a dynamic cell in a spot beam environment.

FIGS. 24A-24E are diagrams illustrating structures that define and operate a mute cell and an active cell for each layer.

FIG. 25 is a diagram illustrating another form of multiple spot beams using multiple beamforming antennas.

FIG. 26 is a diagram illustrating another form of a plurality of beam component carriers for each of a plurality of layers.

FIG. 27 is a diagram illustrating another example of technology that groups and operates beam component carriers for a specific layer.

FIGS. 28A-28F illustrate another example of a method for configuring a dynamic cell in a sector beam environment.

FIGS. 29A-29E are diagrams illustrating another example of structures that define and operate a mute cell and an active cell for each layer.

FIG. 30 is a diagram illustrating one example of a terminal according to an exemplary embodiment of the present invention.

It should be understood that the appended drawings are not necessarily to scale, presenting a somewhat simplified representation of various features illustrative of the basic principles of the invention. The specific design features of the present invention as disclosed herein, comprising, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the accompanying drawings. When reference numerals refer to components of each drawing, it is noted that although the same components are illustrated in different drawings, the same components are referred to by the same reference numerals as possible. In describing the exemplary embodiments of the present invention, when it is determined that the detailed description of the known art related to the present invention may obscure understanding the exemplary embodiments of the present invention, the detailed description thereof will be omitted.

Terms such as first, second, A, B, (a), (b), and the like may be used in describing the components of the exemplary embodiments according to the present invention. The terms are only used to distinguish a constituent element from another constituent element, but nature or an order of the constituent element is not limited by the terms. Further, if it is not contrarily defined, all terms used herein comprising technological or scientific terms have the same meaning as those generally understood by a person with ordinary skill in the art. Terms which are defined in a generally used dictionary should be interpreted to have the same meaning as the meaning in the context of the related art, and are not interpreted as an ideally or excessively formal meaning unless clearly defined in the present invention.

Hereinafter, in the present invention described, one base station handles all of specific FAs of a spot beam as one communication channels to show a macro cell effect of a stable coverage layer. In this regard, the present invention discloses system operation in a hot spot environment of base station switch beamforming and terminal switch beamforming. In particular, in the present invention, the same control and the same data are configured to be transmitted to and received at the same TTI in one base station, technology such as SISO or switched beamforming is applied in the base station, and a terminal performs optimal beam selection through switched beam tracking. In this operation, the base station may perform multi-beam preparation and the terminal may perform optimal beam selection by a determination condition of the base station. Through the aforementioned operation, a receiving gain of a stable hot spot specific FA may be improved and an effect of using other hot spot FAs as a small cell may be provided.

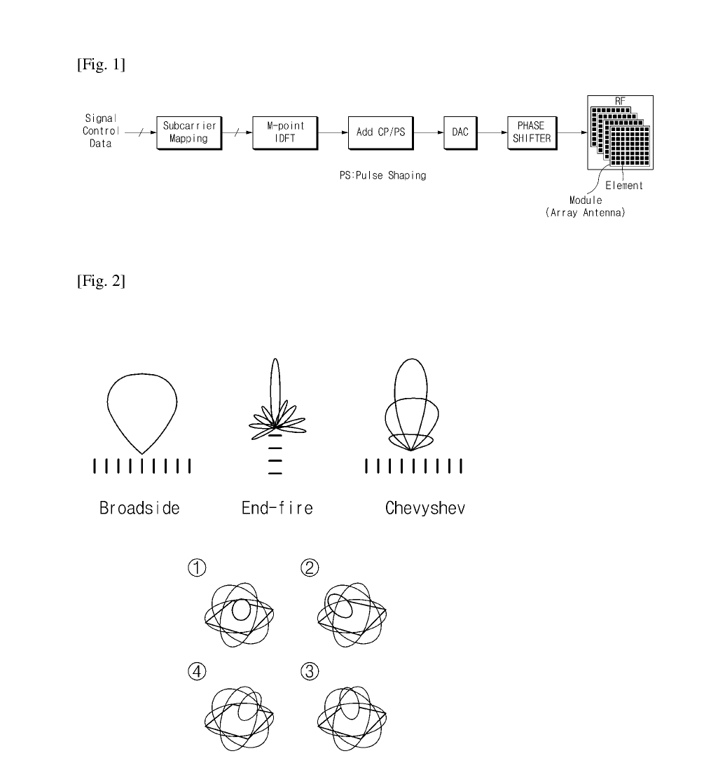

FIG. 1 is a diagram illustrating an array RF assembly according to an exemplary embodiment of the present invention.

Referring to FIG. 1, a communication module comprising an array RF assembly according to the present invention may include a subcarrier mapping module, an M-point IDFT module, an Add CP/PS module, a DAC module, a phase shifter module, and the array RF assembly. The array RF assembly applied to the present invention is formed by combining features of OFDM and an array antenna and the array RF assembly may be an array antenna module (hereinafter, referred to as AAM) in which one element may form one beam or several elements are disposed in a module form by a specific rule. The array RF assembly may more sharply make the beam according to an array form. In illustrated FIG. 1, the array antenna module (AAM) of 8×8 is exemplified and may be AAM of N×N. The array RF assembly is formed by gathering one or more AAMs to form one beam. The RF antenna assembly of FIG. 1 may generate various beam patterns comprising Broadside, End-fire, and Chevyshev according to various arrays.

FIG. 2 is a diagram illustrating a beam pattern according to an array of an RF antenna assembly according to the present invention.

Referring to FIG. 2, by adjusting the array of the RF antenna assembly, various beam patterns comprising Broadside, End-fire, and Chevyshev may be generated. As various examples, the communication module may rapidly change (beam-steer) a direction of the beam by not a mechanical method but an electronic method with respect to the same beam pattern through phase control of each element of the RF antenna assembly.

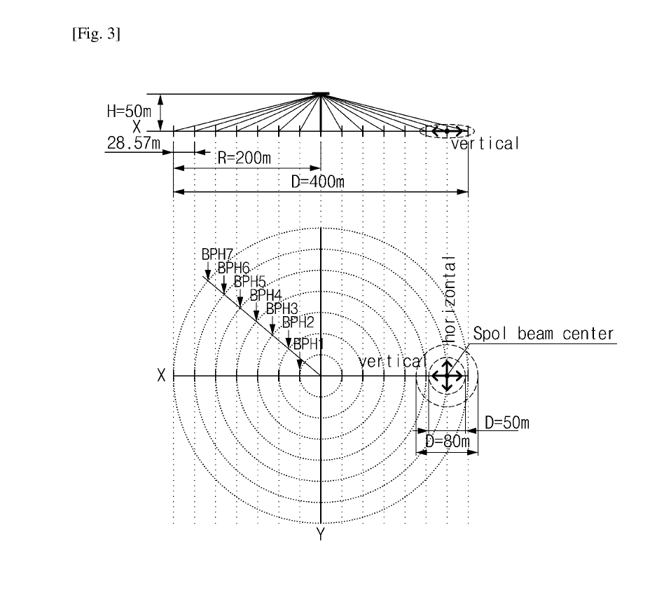

FIG. 3 is a diagram illustrating a method for constituting a base station antenna using multiple beamforming antennas.

Referring to FIG. 3, when a base station antenna is disposed at one arc center, an effective beam area having a diameter (e.g., 80 m) and a non-overlapping beam area having a diameter (e.g., 50 m) may be defined based on a bottom surface projection at a spot beam center of a spot beam by considering characteristics and performance of a beamforming antenna and base station coverage (e.g., 400 m) and a height (H 50 m) regardless of whether a patch array antenna type beamforming antenna is used or a horn-type beamforming antenna is used.

When the effective beam area and non-overlapping beam area based on the bottom projection surface of the beamforming antenna are determined by considering the characteristics and performance of the beamforming antenna and the base station coverage, and the height H, the non-overlapping beam area is referred to as arc dotted lines (Base Station Phase 1 (BPH1) in which the arc center having a predetermined diameter D (e.g., 50 m) and the center of the base station antenna coincide with each other in FIG. 3 and a beam center circle (projected baseline beam center circle) in which the beamforming antenna mounted on the BPH1 is basically oriented and a projection beam center circle having a width (e.g., D×½=25 m) corresponding to a half a diameter of the non-overlapping beam area may be drawn. A spot beam center of the beamforming antennas mounted on BPH2, BPH3, BPH4, BPH5, BPH6, and BPH7 illustrated in FIG. 3 has a projection beam center circle projected by each mounted BPH. Herein, a width among the respective beam center circles may just define the non-overlapping beam area by considering a predetermined diameter (e.g., D=400 m) of the base station coverage, the number (e.g., 7) of BPHs, and a predetermined width (e.g., 400/(7*2)=28.57).

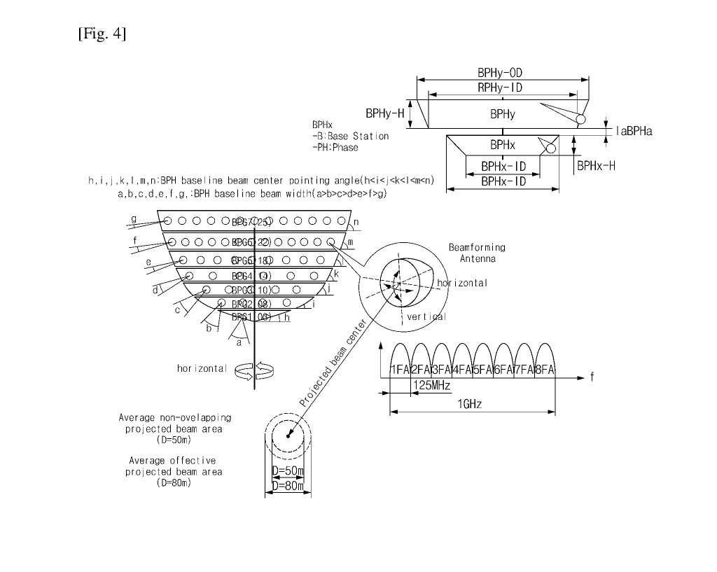

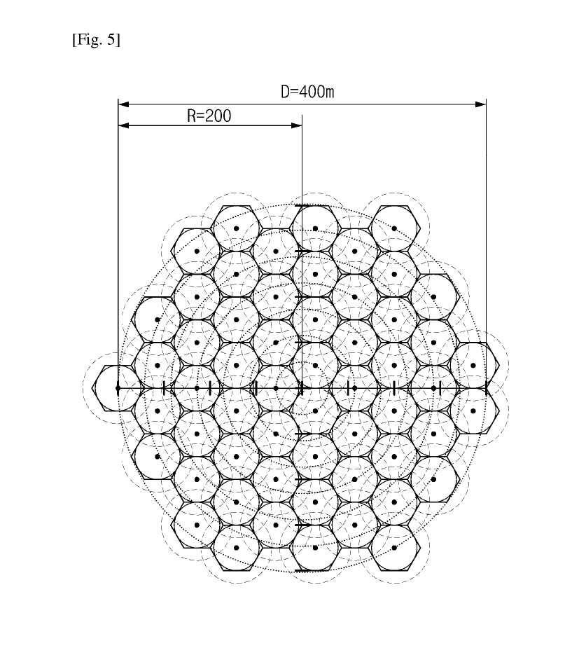

FIG. 4 is a diagram illustrating a projection beam center circle for each BPH according to an exemplary embodiment of the present invention.

The BRH may mean a stacked ring type end on which multiple beamforming antennas capable of forming multiple spot beams are mounted. The entirety of the base station coverage may be constituted by multiple spot beams by stacking the multiple BPHs.

Each BPH described in FIG. 4 may have the projection beam center circle for each BPH of FIG. 3. In this case, the center of the beam formed by the spot beam forming beamforming antennas basically mounted on the corresponding BPH is positioned in the same beam center circle. To this end, the respective BPHs have BPH baseline beam center pointing angles (BPH reference beam center orientation angles) of h, i, j, k, l, m, and n and basically have a characteristic of h<i<j<k<l<m<n. Further, BPH baseline beam widths (BPH reference beam widths) such as a, b, c, d, e, f, and g are acquired for each BPH and a characteristic of a>b>c>d>e>f>g is basically acquired in order to acquire an average effective projection beam area (e.g., D=80 m) and an average non-overlapping projection beam area (e.g., D=50 m) regardless of the BPH. The BPH reference beam center orientation angle and the BPH reference beam width consider a characteristic and performance of the beamforming antenna mounted for each BPH and consequently, the BPHs are stacked by designing BPHx-ID (Inner Diameter), BPHx-OD (Outer Diameter), BPHx-H (Height), IaBPSs (interval among BPHs) for each BPH. That is, when the beamforming antenna mounted for each BPH is the same BPH, since the BPH reference beam center orientation angle and the BPH reference beam width are acquired, the beamforming antenna mounted for each BPH is a beamforming antenna having the same performance and the same characteristic.

Through the design, the spot beam of the base station may basically have the same average effective projection beam dimension regardless of the BPH. Further, a projected beam center of an end-fire type spot beam radiated from the antenna mounted for each BPH is positioned in the projection reference beam center circle of each BPH. In addition, the number of beamforming antennas which may be mounted on each BPH may be limited. For example, BPH7 25 may mean that beamforming antennas may be disposed at an angle corresponding to 360/25 based on 360°, and as a result, a total of 25 beamforming antennas may be mounted.

The projected beam center for the spot beam formed by the beamforming antennas for each BPH is positioned in the projection reference beam center circle for each BPH and has the average effective projection beam area according to the entire base station design in FIGS. 3 and 4. However, in this case, inter-spot beam interference may occur. The beamforming antennas illustrated in FIG. 4 is designed to tilt the average effective projection beam area oriented through the BPH reference beam center orientation angle and the BPH reference beam width mechanically vertically and horizontally (the case of the patch array antenna may support beam tilting to be enabled through beam steering using electronic phase control, but the mechanical beam tilting may be basically achieved.

Consequently, the respective spot beams are designed to be configured so as to guarantee the average non-overlapping beam area (e.g., D=50 m dotted line) to some degreethrough the beam tilting to design the entire antenna structure of the base station so as to physically reduce inter-beam interference. In other words, in the entire antenna structure of the base station, the inter-beam interference may be physically reduced by disposing the beam tilting of the spot beams so as to guarantee the average non-overlapping beam area with a designated size or more. Further, the BPH reference beam center orientation angle for each BPH and the BPH reference beam width for each BPH are determined according to BPHx-ID, BPHx-OD, BPHy-H, IaBPSs, and an antenna height for each BPH and the performance and characteristics of the beamforming antenna may be complemented by an entire antenna design parameter design of the base station.

FIG. 5 is a diagram illustrating a beamforming antenna based base station coverage according to an exemplary embodiment of the present invention.

Referring to FIG. 5, a point disposed at the center of a predetermined area (e.g., illustrated hexagons) may mean that a beam center oriented by one beamforming antenna is projected to the bottom surface at the center of the base station. A circular line drawn around the point may mean a projected non-overlapping beam area and may be expressed even by the hexagon. Larger dotted lines (e.g., circles having a predetermined size) comprising the circular line and the hexagonal line mean the projected effective beam area and the larger dotted lines are reduced according to the performance of each beamforming antenna to minimize an overlapping area between the beams. In FIG. 5, a form that covers one base station coverage through 57 beams formed through 57 beamforming antennas is illustrated. The non-overlapping beam areas projected between the beams formed by the beamforming antenna do not overlap with each other.

An example of design of the base station antenna for constituting a service coverage of the base station by multiple spot beams as illustrated in FIG. 5 is shown in Table 1 (The design example of overall MWMSB BS Antenna) given below.

TABLE 1

| BPH | a* | b* | c* | d* | e* |
|---|---|---|---|---|---|
| BPH7 | 50.0 | 4.152/3.848/0.6 | 0.2(6-7) | 09/18 | g 04.00/n 75.83 |
| BPH6 | 49.2 | 3.749/3.451/0.6 | 0.2(5-6) | 06/18 | f 05.29/m 73.83 |
| BPH5 | 48.4 | 3.346/3.054/0.6 | 0.2(4-5) | 15/15 | e 07.34/l 71.09 |
| BPH4 | 47.6 | 2.944/2.656/0.6 | 0.2(3-4) | 15/15 | d 10.85/k 67.14 |
| BPH3 | 46.8 | 2.541/2.259/0.6 | 0.2(2-3) | 06/09 | c 17.43/j 61.02 |
| BPH2 | 46.0 | 2.139/1.861/0.6 | 0.2(1-2) | 03/06 | b 30.56/i 50.67 |
| BPH1 | 45.2 | 1.736/1.464/0.6 | — | 03/03 | a 49.83/h 31.57 |

a*: -AH [m],
b*: -OD/-ID/-H[m],
c*: IaBPHs[m]
d*: Beamforming antenna number(real mounted/available mounted)
e*: Baseline beam width/baseline center pointing angle [degree]

As an example of BPH7, in a*, BPH7-AH is 50 m and in b*, BPH7-OD is 4.152 m, BPH7-ID is 3.848 m, BPH7-H is 0.6 m, and IaBPHs(6-7) corresponding to an interval between BPH7 and BPH6 is 0.2 m. In d*, the number of beamforming antennas which may be mounted on BPH7 is 18, but the number of beamforming antennas actually mounted on BPH7 to make the coverage constituted by the spot beam of FIG. 5 is 9, g corresponding to the BPH7 baseline beam width is 4°, and n corresponding to the BPH7 baseline beam center pointing angle is 75.83°. The projected beam center circle illustrated in FIG. 3 and the interval between the beam center circles are designed by considering implementation performance of the beamforming antenna and the design of Table 1 is performed so that the spot beams become the same spot beam to be densely constituted as illustrated in FIG. 5.

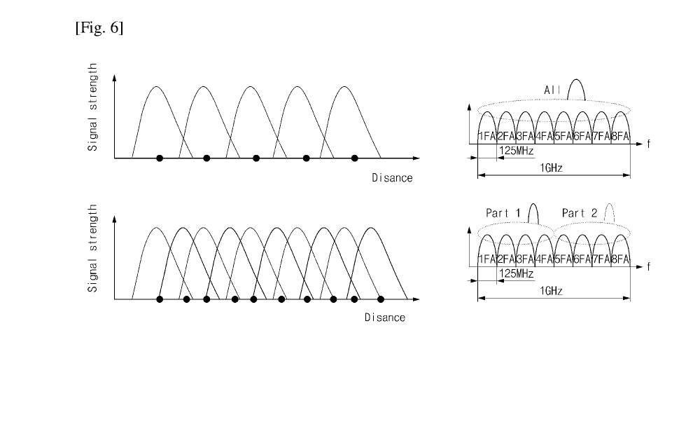

Referring to FIG. 5, when the base station coverage is constituted as illustrated by using multiple beamforming antennas forming the spot beam, the capacity of the base station may be remarkably increased similarly to a case in which 57 small cells are separately disposed for each area. However, when 57 independent small cells are disposed, performance deterioration of a terminal positioned on a boundary of the spot beams may be anticipated similarly to performance deterioration of the terminal positioned on a cell boundary between the small cells. Further, rapid and frequent handover of the terminal positioned in an area between the spot beams may occur and rapid and frequent beam switching of the base station may occur to correspond thereto. Therefore, in the structure illustrated in FIG. 5, only base station layout design using the beamforming antennas capable of forming multiple spot beams for capacity increase may be implemented and a systematic operation for a performance deterioration part caused due to beam switching or a beam boundary location may be required. The entire antenna structure of the base station for physically solving the performance deterioration part is described in FIG. 6.

FIG. 6 is a diagram illustrating one example of an entire antenna structure of a base station according to an exemplary embodiment of the present invention.

An upper end of FIG. 6 defines a beam component carrier by dividing a millimeter wave wideband 1 GHz into unit frequencies of 125 MHz and may correspond to a case in which the entire wideband is formed by one beam. Under such an environment, in the case of a terminal positioned on the boundary of the beam or a terminal which is handed over, performance deterioration and a handover failure may be caused by the interference. Meanwhile, a lower end of FIG. 6 may correspond to a case in which 8 beam component carriers are separated into two groups (herein, two groups, but may be variously divided) to dispose a beam using Part1 and a beam using Part2 to overlap with each other. Under such an environment, since good signal quality for another part is sensed on a beam boundary of a specific part, it is possible to make a detour to a side where interference is weak.

In the upper end of FIG. 6, there is a part where it is difficult to implement beam performance required under an environment in which the performance (manufacturing various beamforming antennas for each BPH so as to prevent a coverage hole from being generated while minimizing the overlapping beam area) of the beam needs to be increased in order to guarantee the non-overlapping projection beam area. However, a use frequency at the lower end of FIG. 6 is divided to overlap with each other to make the effective projection beam area of Part 1 overlap with each other with a designated size or another Part 2 covers the part even though the effective projection beam areas is prevented from overlapping with each other, and as a result, it is possible to connect the corresponding part to a side without interference.

### Exemplary Embodiment 1

### BPH-Based Stacked Base Station Antenna Structure Having Frequency Division Overlapping Beam Layout Structure

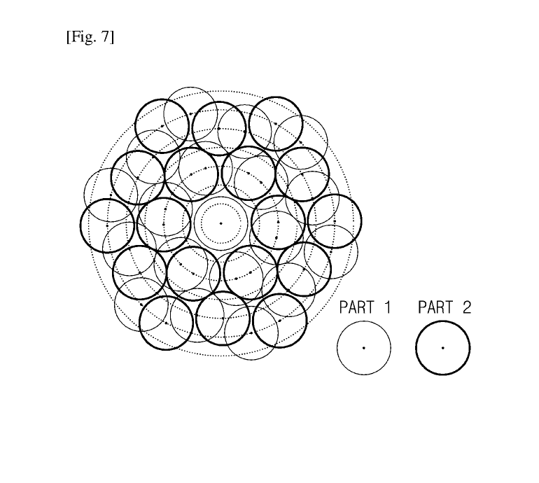

FIG. 7 is a diagram illustrating one example of beam planning using effective divided projection beam areas according to an exemplary embodiment of the present invention.

The example of the layout illustrated at the lower end of FIG. 6 may perform beam planning illustrated in FIG. 7 (while beams that belong to Part 1 are prevented from overlapping with each other and beams that belong to Part 2 are also prevented from overlapping with each other, a coverage hole part of Part 1 is covered by Part 2 and on the contrary, a coverage hole part of Part 2 is covered by Part 1). In this case, the antenna structure of the base station is similar to that of FIG. 4. Unlike the non-overlapping beam layout structure at the upper end of FIG. 6, the location of the beamforming antenna mounted on the BPH may vary. The layout has an advantage in that rapid performance deterioration on the boundary does not occur as the advantage in that there is no inter-beam interference in the non-overlapping beam layout structure, but may have a disadvantage in that the terminal may not acquire a peak capacity. For example, when the terminal uses all of 8 FAs, there is a possibility that the peak capacity will be extracted from all of 8 FAs at the upper end of FIG. 6, but the peak capacity may not be acquired for each FA when 8 FAs are used in the layout of FIG. 7, that is, the lower end of FIG. 6. However, when the terminal is designed so that the terminal uses only 4 FAs, the problem may not occur. However, the beam planning illustrated in FIG. 7 and the lower end of FIG. 6 may be a more fair system having an even capacity in all areas in terms of a system as compared with the beam planning at the upper end of FIG. 6. In FIG. 7, consequently, in the initial base station antenna design, since the beam characteristics and the performance of the beamforming antenna need to be extracted according to the projected effective beam area and the projected non-overlapping beam area of the beamforming antenna, a significant difficulty may be present in actual implementation. However, as illustrated in FIG. 7, the frequency is divided into two partitions and beamforming antennas that take charge of one partition of the frequency are sparsely disposed by considering only a substantial projected effective beam area and in areas which the projected effective beam area may not take charge of, the beamforming antennas that take charge of the other partition of the frequency are disposed to overlap with each other in such a manner to interleave an empty space to provide an advantage in actual layout based on a constraint which is relatively less with respect to the performance and beam pattern characteristics of the beamforming antenna.

### Exemplary Embodiment 2

### Group Beamforming Antenna Based Stacked Base Station Antenna Structure

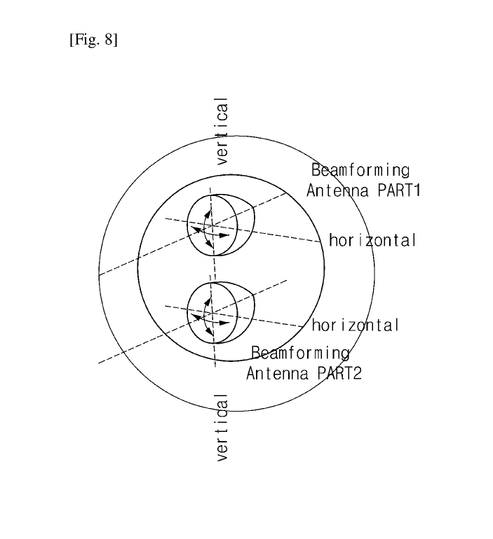

FIG. 8 is a diagram illustrating an example considering mechanical tilting of a beamforming antenna according to an exemplary embodiment of the present invention.

In the entire base station antenna structure of FIG. 4 to which the overlapping beam layout structure of FIG. 7 is applied, the location of the beamforming antenna for each BPH is maintained as it is and the mechanical tilting may be considered by separating the beamforming antenna into beamforming antennas of PART 1(FA1,2,3,4) and PART 2(FA5,6,8,9) as illustrated in FIG. 8. In this case, the entire base station antenna structure of FIG. 4 may not be changed any longer. However, when the beamforming mounting antennas in the BPH are disposed at a regular interval, a tilting angle may be increased.

As various examples, in a mmWave-based multi-sector beam cellular system, as a second type of the base station antenna structure, the beamforming area may be fixed and used by using not the aforementioned patch array antenna but the horn antenna in the case of the base station (in the latter case, the beam steering is not achieved and only the mechanical beam tilting is available). In this regard, not the aforementioned stacked antenna structure but a single-layer antenna structure is made and antennas having the same antenna characteristic are disposed on the circumference of the end.

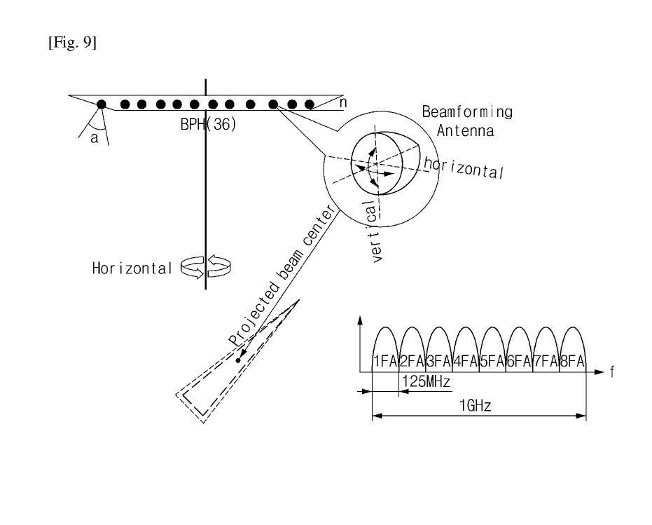

FIG. 9 is a diagram illustrating one example of a plurality of sector beam forming beamforming antennas according to an exemplary embodiment of the present invention.

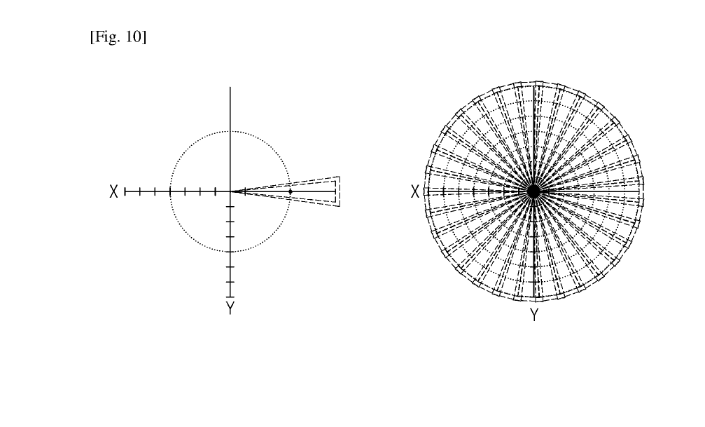

Referring to FIG. 9, only one BPH is present and the number of sector beamforming antennas to be mounted on the BPH may be defined based on an area where the projected non-overlapping sector beam areas do not overlap with each other according to a sector beam forming pattern and performance of the beamforming antenna. BPH 36 may mean a structure in which 36 sector beam forming beamforming antennas are disposed at a regular interval such as 10°. BPH-ID, BPH-OD, and BPH-H are determined according to the beam pattern and performance of the sector beamforming antenna. In addition, a reference beam center circle in which a center of a sector beam is projected may be defined as illustrated in FIG. 10.

FIG. 10 is a diagram illustrating a reference beam center circle in which a center of a sector beam is projected according to the exemplary embodiment of the present invention.

Referring to FIG. 10, when values of n (the number of beamforming antennas) and a (beam areas of the beamforming antennas) of FIG. 9 are determined, the beams may be disposed so as to prevent the projected non-overlapping beam areas of the respective beamforming antennas as illustrated in FIG. 10 from overlapping with each other. The number of sector beamforming antennas mounted on the BPH is not 36 but the sector beamforming antennas may be variously mounted. For example, the number of sector beamforming antennas may be 12 or 6.

As the sector beam planning structure, a frequency division overlapping sector beam layout structure similar to that of FIG. 9 may also be considered in order to reduce an effect of the interference as illustrated in the lower end of FIG. 6. In this case, two methods may be considered. Two BPH ends are made and PART 1 is positioned in one BPH1 and PART 2 is positioned in the other BPH2 to dispose 36 sector beam forming antennas of BPH1 and BPH1 may be disposed while being turned at 5° in order to make an overlapping beam structure in the other BPH2 and although the BPHs are different from each other, the BPH reference beam center orientation angle and the BPH reference beam width may be newly defined so as to keep the same projection reference beam center circle.

As various examples, in a mmWave-based multi-sector beam & multi-spot cellular system, as a third type of the base station antenna structure, the structure of the base station may be made by mixing the spot beam structure of FIGS. 4 and 5 and the sector beam structure of FIGS. 9 and 10. For example, cells are made by using beam grouping through the sector beam structure and a reference signal CRS of the corresponding cell commonly allocated in each beam may be appropriately processed. Under such an environment, the terminal may be positioned in a communication environment similar to the existing cell signal measurement while measuring. To this end, the cells are made by grouping the sector beams to achieve an effect (coverage supporting layer) like a macro cell and the spot beam may serve as a small cell. During this process, the spot beam is separated into a capacity supporting layer to design a base station antenna structure in which the sector beam and the spot beam are mixed.

As various examples, the present invention may provide a terminal antenna structure in the mmWave-based multi-spot or sector beam cellular system.

In the case of the terminal, using the patch array antenna needs to be particularly premised unlike the base station in order to achieve miniaturization and dispose the antenna on the surface of a product. The direction and the shape of the patch antenna which may be mounted may vary according to the shape of the terminal, but a function and operation of the terminal will be described by considering the entire antenna structure of the terminal described below in order to describe the entire structure and operation of the antenna of the terminal (MS, mobile station).

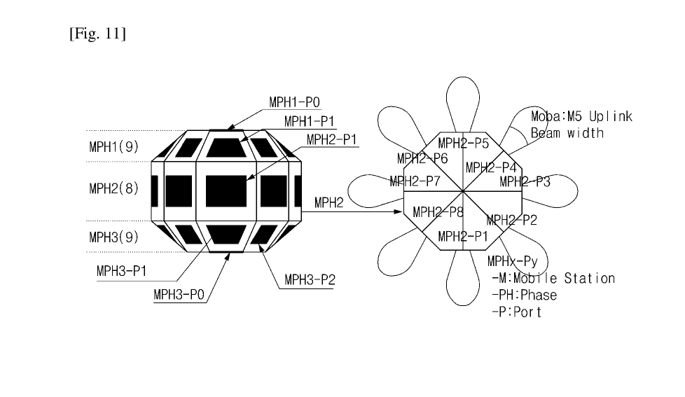

FIG. 11 is a diagram illustrating one example of an antenna structure of a terminal according to the exemplary embodiment of the present invention.

Referring to FIG. 11, the terminal antenna structure is constituted by three mobile station phases (MPHs) and a numeral in parentheses next to the MPH means the number of patch array antennas. For example, MPH2 (8) may mean that 8 patch antennas are mounted on MPH2 (MPH2-P1 to P8) as illustrated at the right side of FIG. 11. MPH1(9) represents that in MPH1, one patch array antenna (MPH1-P0) is mounted above 8 patch array antennas (MPH1-P1 to P8) in addition to 8 patch array antennas (MPH1-P1 to P8). Therefore, it is assumed that the terminal has a total of 26 patch antenna arrays mounted thereon and even in other MPHs, identification numbers may be granted to all patch array antennas of the terminal by combining port numbering (-Px) together with MPHx. In FIG. 11, as one example, the number of patch antennas which may be mounted may be finally determined according to the shape of the terminal.

Designs associated with the entire antenna structure of the terminal, the number of patch array antennas, and an uplink beam width (MS uplink beam width) may be changed by considering coverage by beam and cell planning made by the base station structure and projection beam areas therein under the aforementioned multi-beam environment. In an actual commercialization product, while a real body shape of the MS is maintained as it is, the patch antennas may be mounted on a body surface of the MS.

As various examples, in relation with a system operating method in the mmWave-based multi-spot or sector beam cellular system, the respective base station beams have a cell reference signal corresponding to cells to which the base station beams belong, respectively, and the beam has a unique beam reference signal thereof. Interference may not occur between neighboring beams and neighboring cells regardless of the cell reference signal or the beam unique reference signal. In particular, in beam reference signal design, approximately 16 resource area elements comprising two resource area elements for each of the 8 positions may be considered for each designated (alternatively, specific) time unit and 8 positions may be designated by grouping two resource area elements.

FIG. 12 is a diagram illustrating an absolute start point and a repetition cycle for each beam according to the exemplary embodiment of the present invention.

Referring to FIG. 12, when the beam reference signal is determined with respect to any one beam may mean that an absolute start time, one of 8 positions, and a repetition period are determined. Since the absolute start time is based on SFN & Subframe, the absolute start time may be expressed by combining repeated numerals. For example, since the SFN is repeated from 0 to 4095 and the subframes of the SFN are 0 to 9, the absolute start time may be determined.

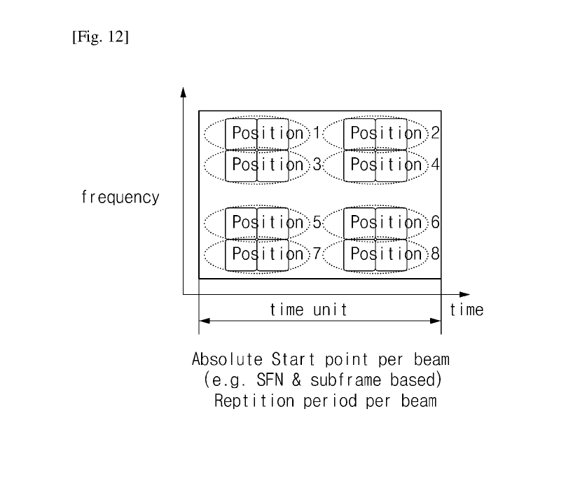

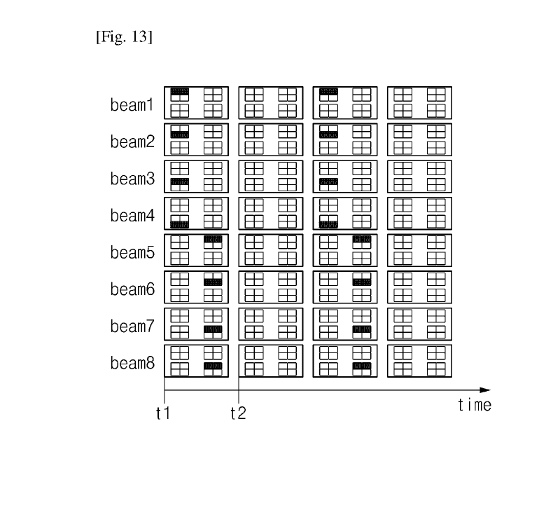

FIG. 13 is a diagram illustrating a location of a reference signal resource element for each beam when beams 1 to 8 have different beam positions at the same absolute start time and the same repetition cycle of 2 time unit.

Referring to FIG. 13, at t1, a reference signal (RS) is set for each location at the same absolute start time and nothing is allocated to other positions. In addition, at a t1+1 time unit, the reference signal (RS) is not set and nothing is allocated to all positions in all beams. However, at a t1+2 time unit, the beam reference signal is allocated to each position according to the position for each beam. Then, when the same absolute start time t2 is given to beams 9 to 16, the positions are differently allocated, and a repetition period of 2 time unit is allocated, resources may be allocated to a total of 16 beams without interference of the beam reference signal. Similarly, when the absolute start time period and the repetition period are controlled, beam reference signals more than 16 may be allocated without interference. However, when the beam repetition period is lengthened, there is a problem in reliability for beam switching in the terminal, and as a result, appropriate design needs to be performed. Making not 8 positions but multiple positions needs to be considered from the viewpoint of the system for the beam reference signal non-interference design. Designing too many positions may incur resource waste.

As various examples, in association with downlink beam selection/reselection and cell selection/reselection in an idle state, a downlink beam of the base station may basically provide the beam unique beam reference signal and a cell grouped by one beam or multiple beams may provide a common cell reference signal. The beam reference signal or the cell reference signal is disposed not to interfere with each other and periodically disposed. The terminal (MS or UE) measures a downlink cell reference signal from 26 MPH ports according to a measurement method and a determination criterion instructed by a network to first arrange the MPH ports from a MPH port having a signal strength of a designated magnitude or more or the best MPH port. The terminal stores a received measurement value for each port in receiving ports associated with a signal having a designated magnitude or more and memorizes one port having the highest signal strength. Further, a soft-combined signal received value (a soft combining cell reference signal received measurement value) is acquired or average values (an average cell reference signal received measurement value) of receiving ports corresponding to a signal level are calculated by considering the number of ports which may be soft-combined and receiving ports corresponding to a designated signal level according to hardware performance. Hereinafter, the soft combining cell reference signal received measurement value or the average cell reference signal received measurement value will be described as the calculated cell reference signal received measurement value.

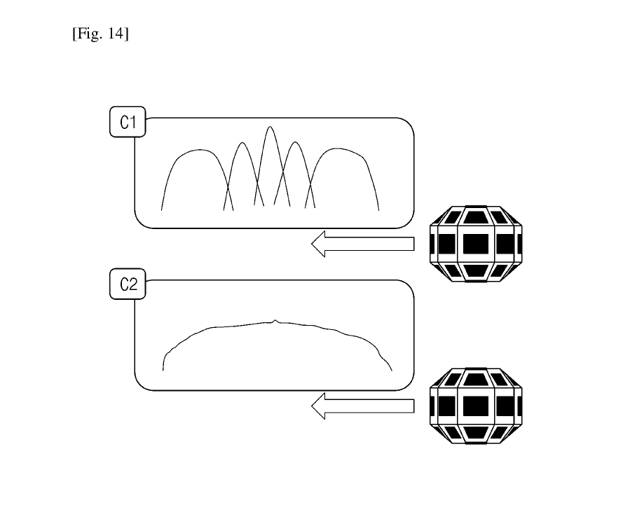

FIG. 14 is a diagram illustrating a cell reference signal for each port according to the exemplary embodiment of the present invention.

Referring to FIG. 14, in association with a C1 state, since the base station beamforming antenna performs predetermined beamforming, the cell reference signal for each beam may be common when it is assumed that the cell reference signal for each beam is measured in LOS. In this case, the cell reference signal (RS) for each port may follow the characteristics of the beam. However, when the calculated cell reference signal received measurement value (average or soft combining) is used, the received measurement characteristic of the cell reference signal similar to the existing received measurement characteristic may be maintained. That is, the terminal determines an uplink port through measurement of the cell reference signal for each port and performs movement among beam groups defined by the cell, that is, inter-cell handover by using the combining and the average cell reference signal measurement value.

The calculated cell reference signal received measurement value is used as a value for performing the inter-cell handover and a port having the largest cell reference signal received measurement value for each port may be a port for uplink transmission. The process of calculating the cell reference signal received measurement value and determining the uplink port to be transmitted may be defined as beam tracking.

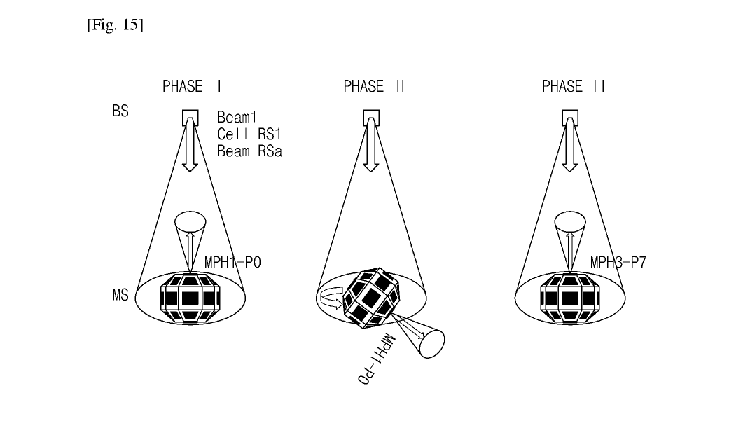

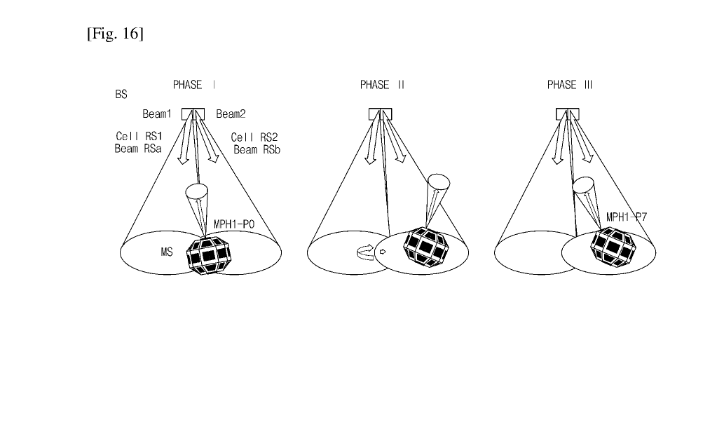

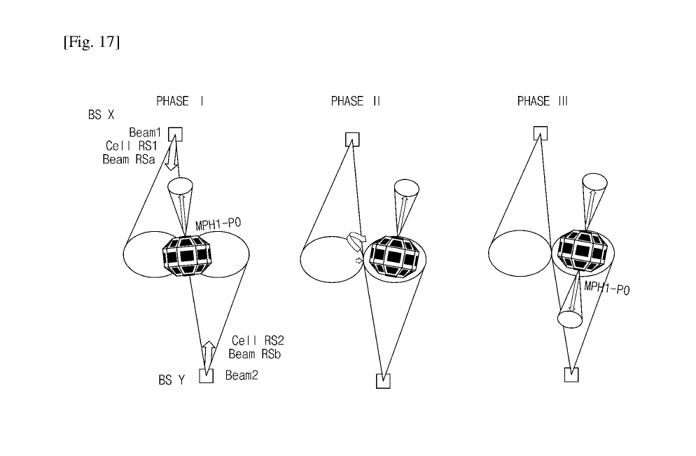

FIG. 15 illustrates a first beam tracking pattern according to an exemplary embodiment of the present invention, FIG. 16 is a second tracking pattern according to an exemplary embodiment of the present invention, and FIG. 17 illustrates a third beam tracking pattern according to an exemplary embodiment of the present invention.

The illustrated beam tracking patterns may be described in an access state in addition to the idle state. However, in terms of the operation, the idle state and the connection state may be different from each other. The respective beams have the cell reference signals corresponding to the cells to which the respective beams belong and the beam has the unique beam reference signal thereof. In the idle state, the beam tracking is completely performed based on the cell reference signal and additionally completed by measurement of the cell reference signal.

Referring to FIG. 15, the beam tracking may be shown as PHASE I, II, and III in the same beam area. The terminal MS may be present in a beam 1 area formed by beamforming antenna 1 and recognize MPH1-P0 which is the port having the largest cell reference signal measurement value in PHASE I by the cell reference signal measurement value for each port (the beam is not radiated through uplink as illustrated in FIG. 15 in the idle state).

Referring to FIG. 16, the beam tracking on a beam boundary formed by two beamforming antennas adjacent to the same base station may be shown as PHASE I, II, and III. As described in FIG. 15, the terminal MS performs the measurement of the cell reference signal from all ports. However, in the case illustrated in FIG. 16, since two beams have the same cell reference signal (Cell RS1), accurately determining the uplink port may be difficult. Therefore, several ports are selected in the order in which the cell reference signal measurement value is larger, several beam signal reference signal measurement values input at a signal level which may be again accepted for each port are found at the selected ports, and a port in which the largest beam reference signal measurement value is input needs to be selected as the uplink port. In PHASE II, as the terminal MS rotatably moves, MPH1-P0 is not an optimal port in which uplink is available any longer and it is found that MPH1-P7 is the most appropriate uplink port through two measurement processes (cell reference signal based measurement and beam reference signal based measurement) again.

Referring to FIG. 17, beam tracking on a boundary region of Beam 1 and Beam 2 of two respective base stations BS X and BS Y may be shown as PHASE I, II, and III. As described in FIG. 16, the terminal determines multiple ports through the cell reference signal measurement value and finds an optimal port through the beam signal reference signal measurement at the determined ports again. However, since the current PHASE I is the cell boundary region, the calculated cell reference signal measurement needs to be performed before the two measurement processes. The terminal performs reception measurement of multiple cell reference signals which may be received from all ports. In this case, Cell RS1 and Cell RS2 are measured and when Cell RS 1 and Cell RS2 are measured by the calculated cell reference signal measuring method, whether Cell RS 1 is larger or Cell RS2 is larger may be compared. The terminal may designate a cell having the larger signal strength as a cell on which the terminal camps. In other words, when Cell RS1 and Cell RS2 are measured at each port, the terminal may combine that the measurement value of Cell RS 1 is at an effective level at each port or acquire a Cell RS 1 based cell reference signal measurement value calculated as the average value. Similarly to this, the terminal may combine that the measurement value of Cell RS2 is at the effective level at each port or acquire a Cell RS2 based cell reference signal measurement value calculated by making the average value. The terminal determines a cell in which the terminal will reside through comparison between the Cell RS1 and Cell RS2 based cell reference signal measurement values.

If Cell RS 1 is determined, the terminal acquires measurement values for multiple beam reference signals having common Cell RS 1 received at the effective port to select the optimal uplink port. In PHASE I, the terminal may determine MPH1-P0 through the aforementioned process. However, when the terminal rotates and moves in PHASE II, while the aforementioned process is continuously repeated, the optimal uplink port is determined. In PHASE III, the terminal may determine MPH31-P0.

When the operating processes of FIGS. 15 to 17 are integrated, first, the measurements for the multiple cell reference signals for each port and the multiple beam reference signal measurements are performed in parallel. The cell on which the terminal will camp may be determined by the cell reference signal measurement value calculated for each cell for the cell reference signal measurement value for each port. The terminal may determine the optimal uplink beam port by the premeasured multiple beam reference signal measurements having the same cell for each effective port of the determined cell. All of the beam/cell selection and reselection processes in the idle state are determined through control by the terminal. When the base station provides neighboring beam information for each any one beam through system information and provides beam reference signal information for each cell in order to support the idle beam tracking, the beam tracking process of the terminal in the idle state may be simplified. The reason is that the beam reference signal for each cell is defined, the base station plans the beam reference signals to be different from each other in different adjacent beams, when neighboring information is provided based on a predetermined beam, the terminal may substantially predict a beam reference signal to be measured in the case where the terminal is positioned on a predetermined cell boundary to reduce measurement complexity or a measurement time. In addition, when a predetermined beam reference signal is input, since the terminal knows a neighboring beam reference signal thereof, the terminal need not blindly measure all beams, and as a result, providing the system information may reduce a time or effort for beam tracking.

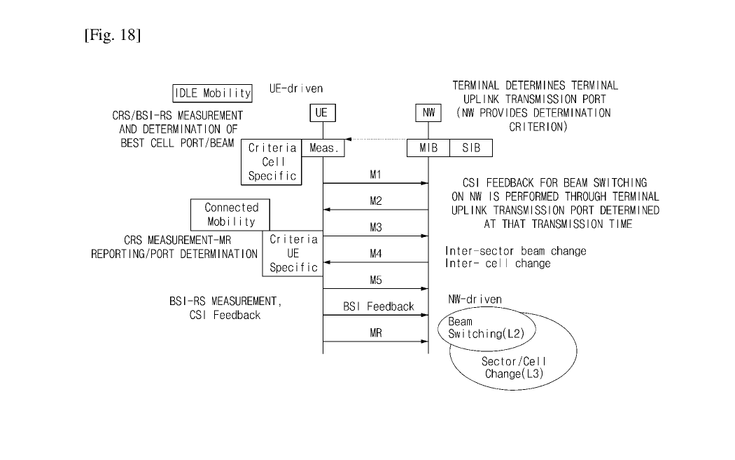

As various examples, in association with downlink beam selection/reselection and cell selection/reselection processes in the access state, the downlink beam selection/reselection and cell selection/reselection processes in the idle state may be referred to as IDLE mobility. The mobility is completely determined by the terminal (UE or MS). However, when the UE in the idle state performs triggering in order to receive a predetermined service, the UE may be operated as illustrated in FIG. 18.

FIG. 18 is a diagram illustrating an operation method of a system according to an exemplary embodiment of the present invention.

During a process of performing beam tracking for determining a best cell and a best port based on the cell reference signal (CRS) for each port/beam specific information reference signal (B SIRS) (e.g., the beam reference signal) by the Idle Mobility, the beam tracking time may be reduced by MIB and SIB information.

Referring to FIG. 18, when the terminal (UE) requests a service, M1 (RACH preamble) attempts to connect to an uplink port designated through the beam tracking in the IDLE. A network (NW) receiving the M1 transmits M2 (random access response—L2 message) to the terminal (UE) and the terminal (UE) receiving M2 transmits M3 (RRCConnectionRequest—L3) to the network (NW). The network (NW) transmits M4 (RRCConnectionSetup) to the terminal (UE) again and the terminal (UE) receiving the M4 transmits to the network (NW) an M5 message (RRCConnectionSetupComplete) notifying that connection is completed to the network (NW). Wireless access may be officially configured between the terminal (UE) and the network (NW) through such a procedure and the network (NW) may provide a method and a reference of terminal (UE) specific measurement into the M4 message.

When cell based information is provided as the SIB information of the IDLE Mobility to reduce the beam tracking time, a required CRS or/and required BSI-RS information is provided to the corresponding terminal (UE) based on the M4 provided by the network (NW) or the subsequent RRCConnectionReconfiguration message to support the terminal (UE) to perform beam tracking based only on the information.

However, in IDLE mobility, when the beam switching and the cell change are performed independently by the terminal (UE) based on the system information provided by the network (NW), the beam tracking of the terminal (UE) is available in the beam determined by the network (NW) in connected mobility, but the network (NW) completely takes charge of the beam switching and the cell change. In the case of the beam switching, the beam switching is performed through DCI information in network (NW) MAC through BSI-RS measurement feedback for multiple beams of which measurement is requested and the cell change is performed through control of L3 through a measurement report (MR-L3 message) for the CRS.

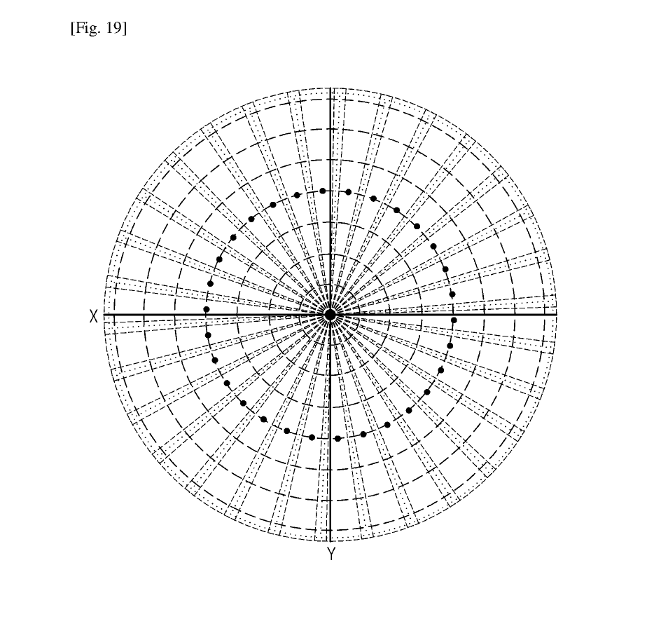

FIG. 19 is a diagram illustrating a service coverage generated by multiple sector beams formed by an antenna structure of a base station using a sector beam structure.

Referring to FIG. 19, in the entire base station antenna structure, multiple beamforming antennas have a beam layout structure of a sector beam form. Points disposed at the center of a circle may mean the center of one sector beam forming beamforming antenna. Triangular inner dotted lines which are formed based on the points may mean a projected non-overlapping beam area. Outer dotted lines surrounding the triangular inner dotted lines may mean a projected effective beam area. The number of beamforming antennas is determined based on the beam pattern and performance of the sector beam forming beamforming antenna and in the projected non-overlapping beam area, the beams are disposed not to cross each other.

For reference, the structures of the sector beam and the spot beam may be mixed and used. In such a configuration, a frequency allocated to the spot beam and a frequency allocated to the sector beam may not overlap with each other.

### Exemplary Embodiment 3

### Method for Configuring Multi-Layer Dynamic Cell in mmWave-Based Multi-Spot Beam Cellular Environment

FIG. 20 is a diagram illustrating multiple spot beams using multiple beamforming antennas.

Referring to FIG. 20, the multiple spot beams may be provided in a form in which a beam is radiated from the center and formed on the bottom surface by using multiple beamforming antennas (e.g., 57) in a base station. One spot beam coverage may be actually constituted by 8 spot beam component carriers (57*8). In the multiple spot beams configured as above, one or more BCCs corresponding to the same layer (the same FA) are gathered to make the cell. That is, one BCC may be one cell, but multiple BCCs may make one cell.

FIG. 21 is a diagram illustrating a beam component carrier for each of the multiple layers.

Referring to FIG. 21 when 8 FAs are regarded as a multi-layer concept, 57 beam component carriers may be present for each of the 8 layers (alternatively, for each layer) as illustrated in FIG. 21. One beam component carrier may be operated as one cell in one layer and several beams are grouped to be operated as one cell. When several beams are operated as the cell, this basically means that several beams are regarded and controlled as one resource and all physical/transmission/logical channels associated with the cell in the existing cellular structure are present. However, multi input multi output (MIMO) in the existing cellular structure is a mode in which several antennas cover the same region, while in the multi-layer dynamic cell type antenna structure of the present invention, multiple beam component carriers may cover different regions. As various examples, in the multi-layer dynamic cell type antenna structure of the present invention, several beam component carriers may regarded as several antennas of the MIMO and resource allocation such as MU-MIMO may be performed. That is, multiple beam component carriers are gathered to be regarded and allocated as one resource, but the respective beam spots that group the resources may be allocated as the forms of the respective resources.

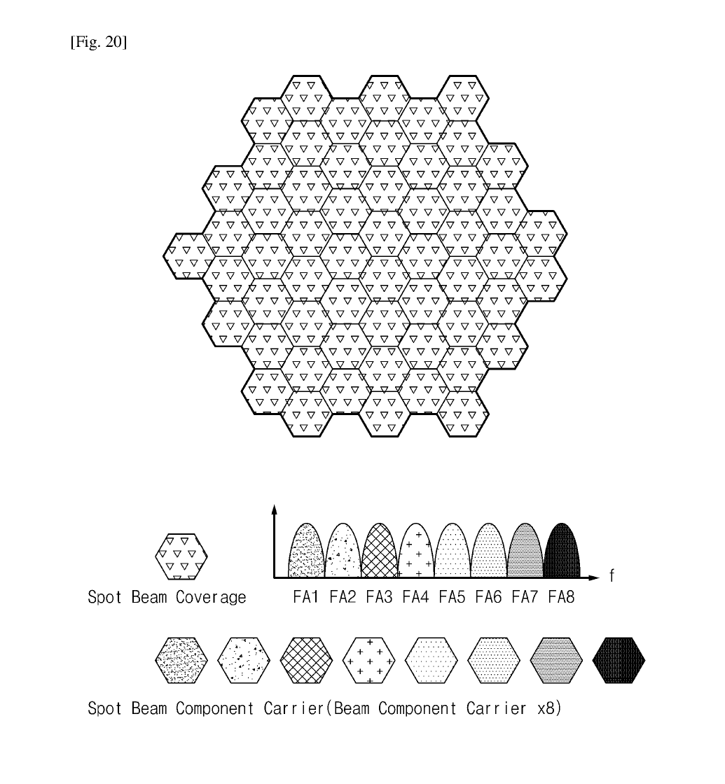

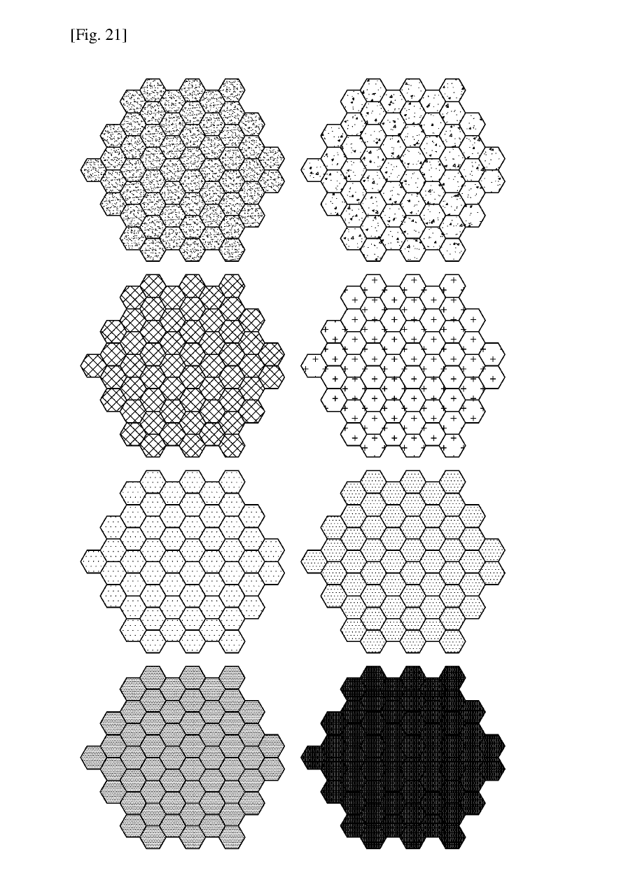

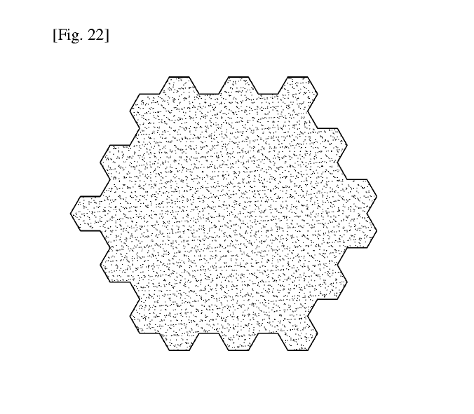

FIG. 22 is a diagram illustrating a technology that groups and operates beam component carriers for a specific layer.

Referring to FIG. 22, since a problem occurs in coverage and rapid connection severance of millimeter waves, largely gathering the beam component carriers for the specific layer and operating the gathered beam carrier components like one cell may basically alleviate the problem in coverage as illustrated in FIG. 22.

FIG. 23 illustrates a method for configuring a dynamic cell in a spot beam environment.

Referring to FIG. 23, as the method for configuring the dynamic cell in the spot beam environment, multiple beam component carriers that are present in the specific layer may be grouped. In FIG. 23, 57/1 may mean that 57 beam component carriers are operated as one cell in the same layer as illustrated in FIG. 22. 19/3 is a method that forms 3 cells by gathering 19 beam component carriers as one cell unit. By the 19/3 structure, a plurality of shapes may be made in respect to the directions of the gathered beam component carriers. The 19/3 structure may not be fixed like two illustrated shapes and a 3-sector structure may be further modified at various angles. The 19/3 structure may be configured in a form similar to the 3-sector structure in the existing cellular system.

9/3 and 10/3 illustrate a form in which 3 cells with 9 beam component carriers are gathered as one cell unit and 3 cells with 10 beam component carriers are gathered as one cell unit are constituted to constitute a total of 6 cells. 9/6 and 3/1 are a form in which 3 cells at the center are gathered to make one cell and 9 cells are gathered to constitute 6 cells on the circumference thereof and are cell layout structures which may not be configured in the existing cellular system. Similarly, 15/3, 12/1, and 9/5, 12/1 are also similar to 9/6 and 3/1 and are the cell layout structure which may not be configured by the existing cellular system. 1/57 means that all beam component carriers of the specific layer independently form the cells. 3/19 means that 3 cells are gathered to constitute one cell and a total of 19 cells are thus formed. The 3/1, 9/1, 15/1, 10/3 structure as the cell structure which may not be shown in the existing cellular structure means a donut type cell configuration. In the aforementioned dynamic cell configuration, the respective spot beams may be constituted in more various forms according to a design scheme or the form of an applied structure as a form that gathers adjacent carriers as a predetermined group unit to constitute the cell in the defined structure scheme.

As various examples, the configuration of FIG. 23 varies for each layer to constitute the multi-layer dynamic cell. For example, an FA1 layer is constituted in the structure of 57/1 (the former 57 means that 57 BCCs are gathered to become one cell and the latter 1 means that the total number of cells in which 57 BCCs are gathered to be one cell is 1) and FA2 (alternatively, FA3) means two 19/3 structures (the former 19 means 19 BCCs are gathered to become one cell and the latter 3 means that the total number of cells in which 19 BCCs are gathered to constitute one cell is 3, and 19/3 means a case where two drawings group of different areas not to coincide with each other, FA4 may be constituted by 15/3 and 12/1 structures (meaning a case where 15 BCCs are gathered to constitute one cell and when the total number of cells is 3 and 12 BCCs constitute one cell and the number of cells is 1, therefore, a total of 4 cells are constituted), and FA5 may be constituted by 9/5 and 12/1 structures, FA6 may be constituted by a 3/19 structure, and FA7 and FA8 may be constituted by 1/57 (meaning that one BCC becomes one cell and the total number of cells is 57). In this case, the FA1 layer serves as the coverage layer to be used as a layer in which all L3 signaling, random access, and paging are available. In addition, residual layers (e.g., FA2, FA3, FA4, FA5, FA6, FA7, and FA8) may be used as the capacitor layer. For example, terminals which almost stop process data in a cell type layer (e.g., FA7 or FA8) having the 1/57 structure, the beam boundary region process data in a cell type layer (e.g., FA6) having the 3/19 structure of the next upper step, and medium-speed/high-speed terminals may be configured to process data in serviceable layers (e.g., FA5, FA4, FA3, FA2, and the like) in a relatively larger cell area. Layers other than the FA1 layer may be used while being defined as a simple cell (a cell that discharges or transfers only data).

The aforementioned dynamic cell configuration for each of the various layers may alleviate a phenomenon in which wireless access stops through a rapid channel change and abrupt severance which are unique characteristics of the millimeter wave frequency through of the coverage layer effect using large-unit grouping such as 57/1 and the terminal continuously accesses only the coverage layer and performs control of cell connection provided by the capacitor layer through the cell of the coverage layer. In addition, cells of layers which do not interfere with each other through different types of dynamic cell configurations of different forms among the layers illustrated in FIG. 23 are connected to add a capacity required for the terminal. In addition, FA1 which is the coverage area is operated as it is and in the residual capacitor layers, the corresponding beam may be kept in a muting state according to a space-time capacity of the base station or all of the layers may be turned off or when a capacity to be processed increases, the layer may be turned on again or the dynamic beam pattern is supported to be frequently changed.

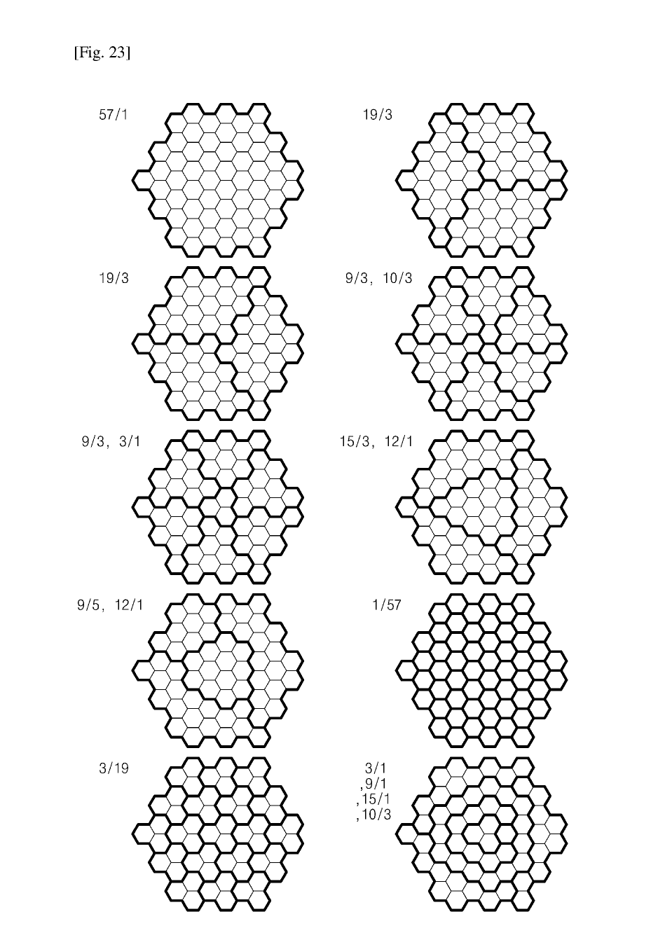

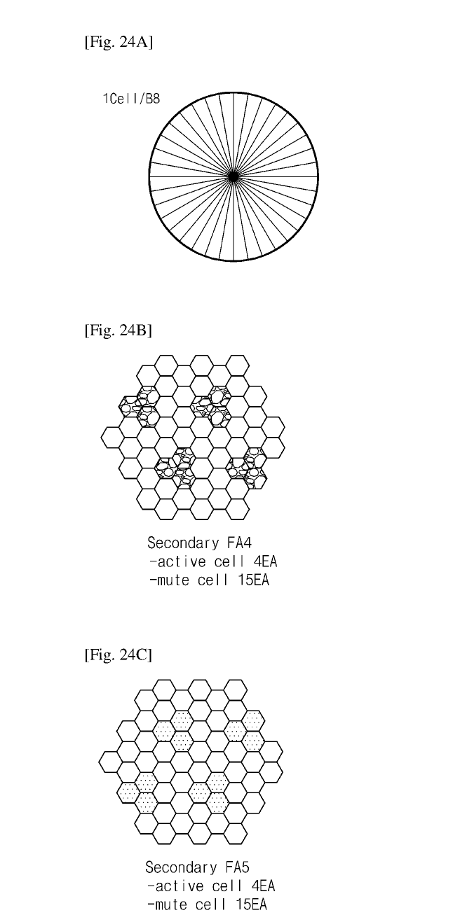

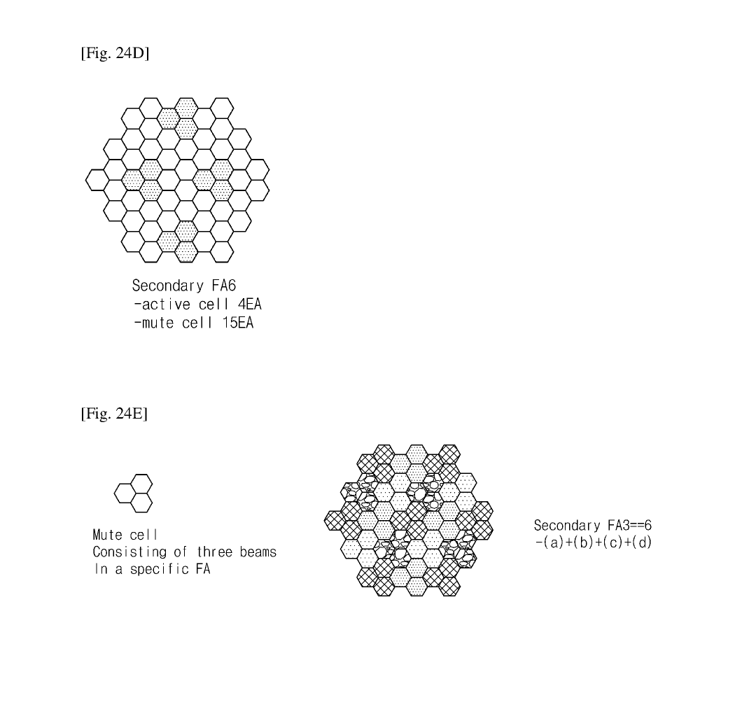

FIGS. 24A-24E are diagrams illustrating structures that define and operate a mute cell and an active cell for each layer.

Referring to FIGS. 24A-24E, in the exemplary embodiment of the present invention, as characteristics of only the spot beam structure, the mute cell and the active cell are defined for each layer and the 3/19 structure which does not interfere with 4 layers may be made. Consequently, the spot beam structure may alleviate disadvantages comprising inter-beam interference, deterioration of moving performance, and the like in using the millimeter waves itself through the dynamic cell configuration for each layer. FIG. 24A illustrates secondary FA3 in which 7 activated cells and 12 muted cells are disposed in the 3/19 structure, FIG. 24B illustrates secondary FA4 in which 4 activated cells and 15 muted cells are disposed in the 3/19 structure, FIG. 24C illustrates secondary FA5 in which 4 activated cells and 15 muted cells are disposed in the 3/19 structure, FIG. 24D illustrates secondary FA6 in which 4 activated cells and 15 muted cells are disposed in the 3/19 structure, and FIG. 24E illustrates a service area in which the activated cells of the secondary FA3, FA4, FA5, and FA6 overlap with each other in the 3/19 structure to cover the entirety of the base station coverage.

### Exemplary Embodiment 4

### Method for Configuring Multi-Layer Dynamic Cell in mmWave-Based Multi-Sector Beam Cellular Environment

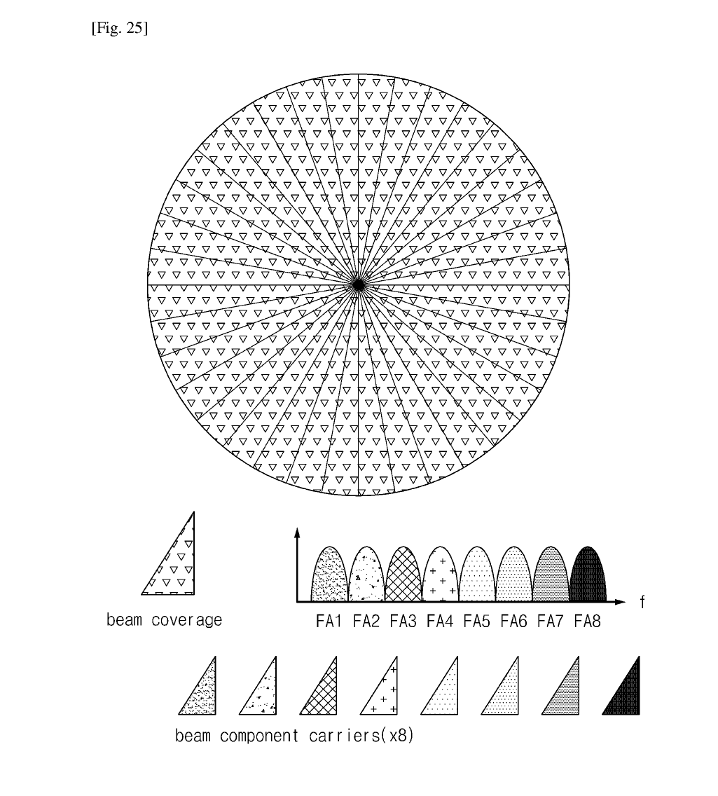

FIG. 25 is a diagram illustrating another form of multiple sector beams using multiple beamforming antennas.

Referring to FIG. 25, multiple sector beams are formed on the bottom surface by radiating a beam from the center by using beamforming antennas (e.g., 36) forming multiple sector beams in the base station. One beam coverage is actually constituted by 8 beam component carriers (36*8).

FIG. 26 is a diagram illustrating another form of a plurality of beam component carriers for each of a plurality of layers.

Referring to FIG. 26, when 8 FAs are regarded as a multi-layer concept, 36 beam component carriers may be present for each of 8 layers as illustrated in FIG. 26. One beam component carrier may be operated as one cell in one layer and several beams are grouped to be operated as one cell. In the sector beam structure, cells may be constituted, in which all physical/transmission/logical channels associated with the cells in the existing cellular structure are similarly present. In the sector beam structure, multiple beam component carriers may cover different regions. Herein, several beam component carriers may be regarded as several antennas of the MIMO in the related art and the capacity may be increased through the resource allocation such as the MU-MIMO. In the sector beam structure, the multiple beam component carriers are gathered to be regarded and allocated as one resource and as a concept similar to the MIMO, the respective sector beams grouping the resources may be allocated in the respective resource forms.

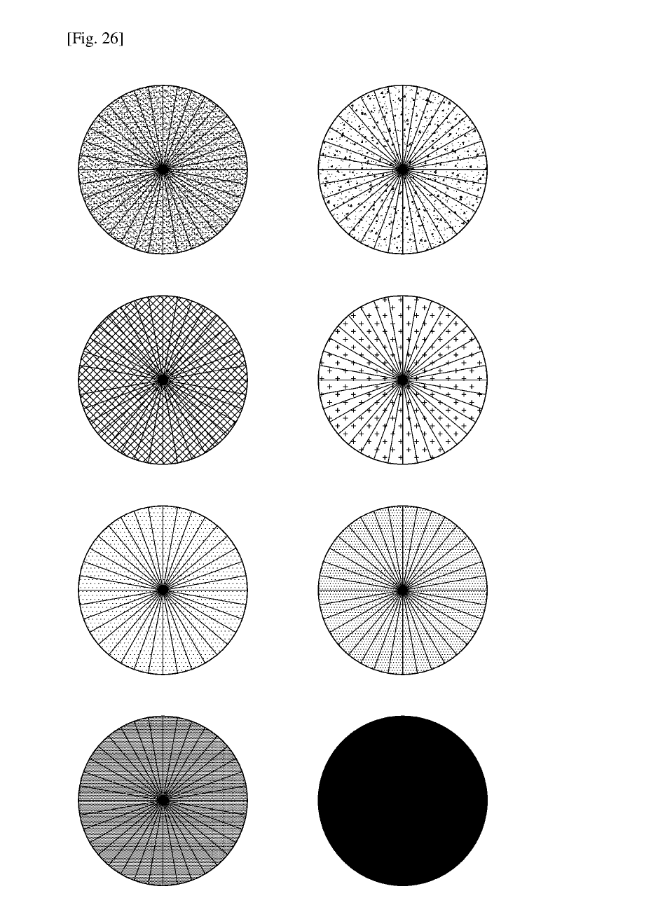

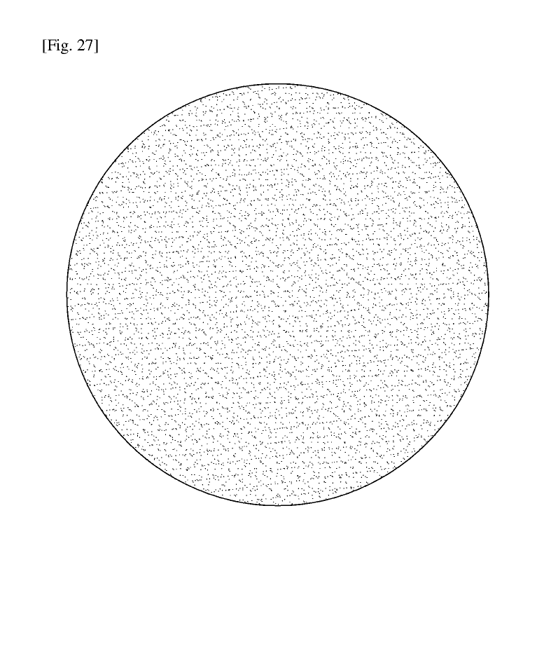

FIG. 27 is a diagram illustrating another example of a technology that groups and operates beam component carriers for a specific layer.

Referring to FIG. 27, since in the case of the millimeter wave, a problem of interruption of the wireless access occurs due to a rapid channel change and abrupt severance which are unique characteristics of millimeter wave frequencies, the problem may be basically alleviated through a coverage effect of a form of largely gathering the beam component carriers for the specific layer and operating the gathered beam carrier components like one cell as illustrated in FIG. 27.

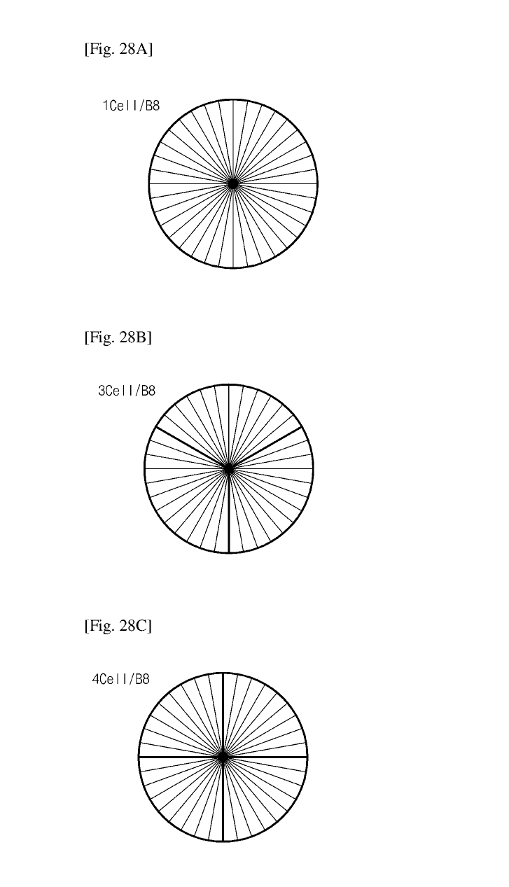

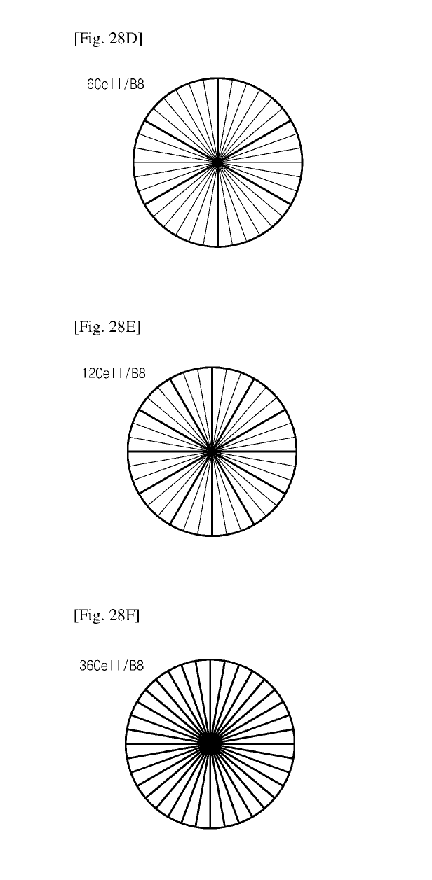

FIGS. 28A-28F illustrate another example of a method for configuring a dynamic cell in a sector beam environment.

Referring to FIGS. 28A-28F, as the method for configuring the dynamic cell in the sector beam environment, multiple sector beam component carriers that are present in the specific layer may be grouped. FIG. 28A illustrated as 36/1 means that all of 36 sector beam component carriers are grouped and used as one cell. FIG. 28B illustrated as 12/3 means that 12 sector beam component carriers are gathered as one cell to form three cells and since the 12 sector beam component carriers may be gathered at various angles, various sector cells may be formed without fixation as compared with the existing cellular structure. FIG. 28C illustrated as 9/4 means that 9 sector beam component carriers are grouped to constitute 4 cells. FIG. 28D illustrated as 6/6 means that 6 sector beam component carriers are grouped to constitute 6 sector cells. FIG. 28E illustrated as 3/12 means that 3 sector beam component carriers are grouped to constitute 12 cells. FIG. 28F illustrated as 1/36 means that each of one sector beam component carrier is constituted by one cell to constitute a total of 36 cells.

As various examples, the configuration of FIGS. 28A-28F varies for each layer to constitute the multi-layer dynamic cell. For example, FA1 is constituted in the form of FIG. 28A and FA2 and FA3 are constituted in the form of FIG. 28B and may be configured to overlap with each other in the middle. FA5 may be constituted in the form of FIG. 28C, FA6 may be constituted in the form of FIG. 28D, FA7 may be constituted in the form of FIG. 28E, and FA8 may be constituted in the form of FIG. 28F. FA1 serves as the coverage layer to be used as a layer in which all L3 signaling, random access, and paging are available and the residual layers may be used as the capacitor layer. For example, terminals which almost stop distribute (alternatively, transfer) data to the layer constituted in the form of FIG. 28F and the beam boundary region move to FIGS. 28E, 28D, and 28C configured more widely as the next upper steps and when there is a layer having a better received signal, the beam boundary region may distribute data to the corresponding layer. When terminal information is provided to the system (e.g., the base station) so that the system recognizes the speed of the terminal, a data transmission speed associated with the terminal is divided into stop, low-speed, and medium-speed, and high-speed steps and data may be distributed to a layer having a relatively larger (alternatively, smaller) cell area or a layer without interference to correspond to the respective speeds. Layers other than the FA1 layer may be used while being defined as a simple cell (a cell that discharges (alternatively, distributes or transfers) only data).

The aforementioned dynamic cell configuration for each of various layers may alleviate a phenomenon in which wireless access stops through a rapid channel change and abrupt severance which are unique characteristics of the millimeter wave frequency through the coverage layer effect using large-unit grouping such as 36/1 and the terminal continuously accesses only the coverage layer and performs control of cell connection provided by the capacitor layer through the cell of the coverage layer. In addition, cells of layers which do not interfere with each other through different types of dynamic cell configurations among the layers illustrated in FIG. 23 are connected to add a capacity required for the terminal. In addition, FA1 as the coverage area is operated as it is and processing such as a muting state of the corresponding beam, a turn-off state of the entire layer, changing a turn-off state to a turn-on state to correspond to an increase in capacity, frequently changing a dynamic beam pattern, and the like may be applied to the residual layers according to the time-space capacity of the base station.

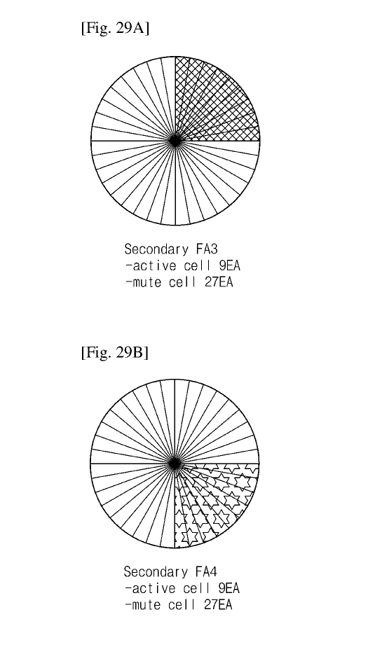

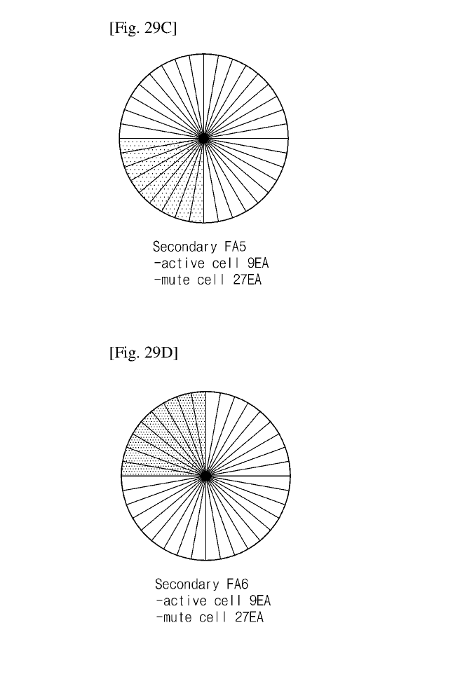

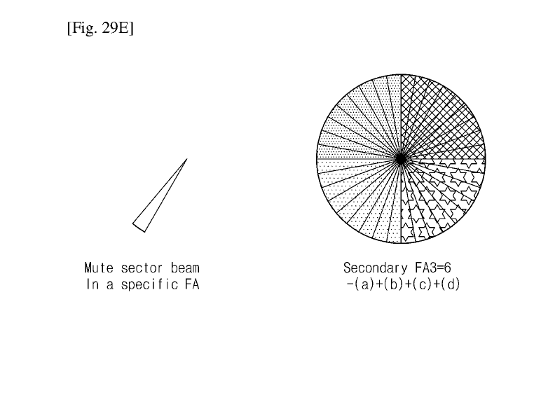

FIGS. 29A-29E are diagrams illustrating another example of structures that define and operate a mute sector cell and an active cell for each layer.

Referring to FIGS. 29A-29E, when the mute sector cell and the active cell are defined for each layer to cross each other as the characteristics of only the sector beam structure, 4 inter-sector cells which do not interfere with each other may be made among 4 beam groups. Referring to FIGS. 29A-29E, in the exemplary embodiment, a secondary FA3 may have a structure in which 9 active cells are disposed on 1-quadrant and 27 mute cells are provided as illustrated in FIG. 29A, a secondary FA4 may have a structure in which 9 active cells are disposed on 4-quadrant and 27 mute cells are provided as illustrated in FIG. 29B, a secondary FA5 may have a structure in which 9 active cells are disposed on 3-quadrant and 27 mute cells are provided as illustrated in FIG. 29C, a secondary FA6 may have a structure in which 9 active cells are disposed on 2-quadrant and 27 mute cells are provided as illustrated in FIG. 29D, and secondary FA3 to FA6 may have at least one of structures in which the active cells are disposed on the respective quadrants as illustrated in FIG. 29E. As described above, the sector beam structure may alleviate the disadvantages comprising the interference, the coverage, and the like of the millimeter waves through the dynamic cell configuration for each layer.

### Exemplary Embodiment 5

### Method for Configuring Multi-Layer Dynamic Cell in mmWave-Based Multi-Sector Anchor Multi-Spot Subsidiary Cellular Environment

As described above, in the case of the base station antenna structure according to the exemplary embodiment of the present invention, the entire antenna structure of the base station may be designed only by the spot beam layout structure of only FIG. 5 or only the sector beam layout structure of FIG. 19. Additionally, any layer may have the spot beam layout structure illustrated in FIG. 5 for each layer of FIG. 5 or any other layer may have the sector beam structure illustrated in FIG. 19. For example, when handover based on the cell reference signal (CRS) of the terminal is performed, the coverage layer groups the sector beams in the sector beam layout structure to form one coverage so as to have the measurement characteristics of the existing cellular structure. Further, the base station antenna structure adopts the spot beam layout structure to support the capacity operation. The aforementioned example is one example and the present invention may provide various forms of configurations by mixing Exemplary embodiments 3 and 4.

### Exemplary Embodiment 6

### Operating System in mmWave-Based Multi-Beam Environment

In the spot beam layout structure, the sector beam layout structure, or the spot/sector beam mixing layout structure, the system operation in the mmWave-based multi-beam environment is similar to a 3GPP LTE or LTE-A system. For example, system entities are the same as MS, BS, and evolved packet core (EPC) and a protocol structure is also constituted by PHY, MAC (Medium Access Control), RRC (Radio Resource Control), PDCP (Packet Data Convergence Protocol), GTP (GPRS Tunneling Protocol), NAS (Non-Access Stratum), S1AP (S1 Application Protocol), and X2AP (X2 Application Protocol), a physical signal and channel, a transport channel, and a logical channel and mutual channel mapping are the same as each other except for MBMS (Multimedia Broadcast Multicast Service) and the system operation is similar. A primary difference in system operation is described below.

The same cell reference signal (CRS position) is allocated to a beam defined as the same cell by grouping specific beam component carriers that belong to a specific layer (the aforementioned dynamic cell configuration for each layer) and the corresponding beam component carrier group is regarded as one cell to integrate and operate the group beam component carriers like the cells of the existing cellular system. For example, all of the beam component carriers of the specific layer constituting the coverage of the base station may be made as one cell and some of the beam component carriers of the specific layer are grouped to make one layer by several cells by differentiating the CRS position for each group.

The terminal performs beam tracking based on CRS measurement and the beam reference signal (herein, referred to as BRS or BSI-RS) for each receiving port. The beam tracking means a series of processes in which the terminal selects the uplink port based on measurement values received through several ports. PSS, SSS, PBCH, PCFICH, PDCCH, PHICH, PDCCH, PUCCH, and PRACH are commonly operated with respect to all beam component carriers defined as the same cell. It makes it a rule to independently operate PDSCH and PUSCH for each beam with respect to the beam components defined as the cell.

Exception cases of the rule of independently operating the PDSCH and the PUSCH for each beam are described below.

Exception case 1: paging, system information (SI), random access response L2 message

Exception case 2: Since the RRC signal message is very important signaling, all beam component carriers defined as the cell are allocated to the same resource area to increase reliability of signal transfer, thereby improving receiving and transmitting qualities of the signal through effects of joint transmission and joint reception. Further, when implement is difficult due to complexity of downlink joint transmission and uplink joint transmission, a resource for transmitting RRC signaling may be allocated to only a beam having a best feedback from the terminal or neighboring beams thereof and the corresponding resource areas for residual beams may be muted in the case of the downlink. Similarly, in the case of the uplink, the resource for the RRC signaling may be allocated to only an uplink resource of any one receiving beam component carrier of the base station and no resource may be allocated to residual other beam component carriers. The transmitting/receiving reliability for the RRC signaling may be increased through the joint transmission/joint reception (JT/JR) method for all beams or some anticipated beam component carriers defined as the cell and the method that allocates the resource to one beam component carrier defined as the cell and prevents different data from being allocated to the same resource area with respect to the residual beam component carriers.

Exceptional case 3: Regardless of the spot beam environment or the sector beam environment, the system may be operated by regarding the PDSCH/PUSCH resource as one resource with respect to all beam component carriers defined as the cell through the dynamic cell configuration for each layer. When multiple operation component carriers (the beam component carriers grouped for each layer are defined as one cell) are present from the viewpoint of the base station, one of the operation component carriers is fixed as a primary component carrier and the system may be operated so that the RRC signaling, paging, and initial random access to initial radio connection are achieved only through the operation component carrier (defined as the primary component carrier (PCC)) from the viewpoint of the network.

The system may be operated so that the residual operation component carriers (defined as a secondary component carrier (SCC)) are used primarily for pure data transmission/reception. A difference from carrier aggregation of the existing LTE-A is that the beam component carriers are gathered to become one operation component carrier and since in the case of the PCC and the SCC, a CC that attempts initial random access becomes the PCC as technology from the viewpoint of the terminal, when operations CCs 1, 2, and 3 are present from the viewpoint of the base station, the PCC may become CC 1 from the viewpoint of terminal A and the PCC may become CC 2 from the viewpoint of terminal B. Meanwhile, in the case of the carrier aggregation in the multi-beam structure, for example, the PCC becomes CC 1 similarly from the viewpoints of both the base station and the terminal. The terminal may perform random access and paging only by CC 1 designated as the PCC.

In spite of the bead component carriers that belong to the same cell, different BSI-RSs (beam reference signals or BRS (is a concept which is the same as the concept of the CSI-RS in LTE, but used for distinguishing the beam component carrier) are allocated to the respective beam component carriers for each beam component carrier and the terminal UE transfers a BSI feedback through the BSI-RS measurement through the PCC PUCCH. The terminal also transfers BSI feedbacks measured in operation component carriers of other layers through the PCC PUSCCH.

In the case of switching among the beam component carriers that belong to the same cell, the corresponding PCC MAC determines beam component carrier switching by using the BSI feedback on the network and the beam component carrier switching is performed by using downlink control information (DCI) of the PDCCH.

The mm-wave based multi-beam cellular system has the following advantages as compared with the existing cellular system. When the same base station coverage is assumed, an average base station capacity may be increased as compared with the exiting cellular system. CAPEX/OPEX may be reduced as compared with a case in which the small cell is disposed and operated at each site in the spot beam area which is the same as the spot beam layout structure. The flexible and optimal system capacity and mobility may be provided through the dynamic cell configuration for each layer according to a change in temporal-spatial user distribution. In the case of the dynamic cell configuration in the spot beam layout structure and the sector beam layout structure, a new form of cell configuration which has not yet been present in the related art is available and since the configuration is very dynamic and flexible, the disadvantage of the mm waves may be overcome and various types of system gains may be obtained by attempting inter-layer dynamic cell configuration as well as intra-layer dynamic cell configuration. For example, a large-scale dynamic cell configuration is formed in terms of the coverage by designating one FA among 8 FAs and this is set to the PCC and the PCC may be primarily used for reliable data transmission/reception such as important signaling and other SCCs may be operated so as to complement inter-beam cell interference in the same layer in other layers. In any layer, a dynamic cell may be reconfigured in terms of the capacity. Consequently, the SCCs are primarily used for data off-loading. For example, a terminal that stops accesses the PCC and measures the signal in order to find whether data is off-loaded from a layer in which dynamic cell configuration of a layer having largest capacity support in terms of the capacity is achieved and when the data-offloading is available, the data is allocated and if not, the terminal performs measurement in order to find whether the data may be off-loaded by moving to a layer having the dynamic cell configuration of a layer having the second largest capacity support.

When a data speed of the terminal may be known, the resource may be allocated by verifying a layer having a priority in resource allocation according to the speed level and in this case, as a criterion, a layer may be selected in which the dynamic cell configuration is achieved by smaller-scale SCCs as the data speed is lower and a layer may be selected in which the dynamic cell configuration is achieved by large-scale SCCs as the data speed is higher. As a result, a low-speed user accesses in terms of the capacity and a high-speed user accesses in terms of stability of mobility. Although any layer is selected, when positioning of the corresponding terminal corresponds to an inter-cell boundary, a signal quality is bad and consequently, data transmission/reception is not smooth, and as a result, the signal quality will be measured again by selecting other layers.

When the use of the SCCs is limited only to the use of the data off-loading, all SCCs in which the dynamic cell configuration is achieved in any layer need to be configured as the active cell and only SCCs are not connected and sparsely activated and the residual SCCs may be muted (a state in which only a minimum signal is sent). As a result, since the service is unavailable in a region in which the SCC is muted in one layer, the muted SCC area in a specific layer is made to the active cells and covered by the SCCs in other layers based on inter-layer union, thereby achieving a dense inter-layer dynamic cell configuration. When a traffic load is not heavy, various cell reconfigurations may be changed in real time in terms of a load, mobility, and interference removal in the FA or inter-FA union through interference.

Small cell enhancements (SCE) assume non-ideal backhaul with the small cell and in the air, the MS(=UE) means dual connectivity (one is macro cell, another is small cell) and it is assumed that the MSs are distributively installed at each site as many as the small cells. In the mm-wave based multi-beam layout structure, the spot beam may serve as the small cell similarly to SCE architecture and small cells of various gduxos having more various coverage than the small cell structure of the SCE may be simulated through the dynamic cell configuration for each layer and a macro cell of the SCE, which takes charge of the coverage may also be similarly made through the dynamic cell configuration. In the SCE architecture, by assuming connection of the macro cell and the small cell through the non-ideal backhaul, real-time signaling is unavailable between the macro cell and the small cell, but the real-time signaling is available between the coverage layer and the capacitor layer through the dynamic cell configuration of the multi-beam layout structure.

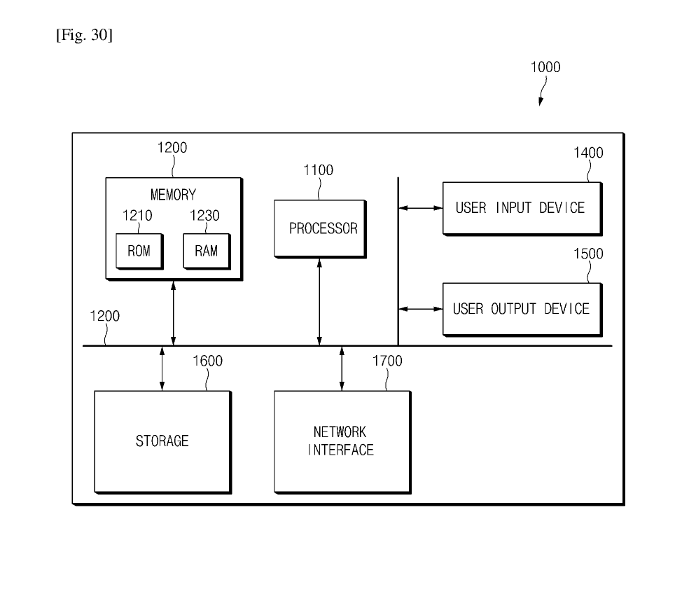

FIG. 30 is a diagram illustrating one example of a terminal according to an exemplary embodiment of the present invention.

Referring to FIG. 30 a computing system 1000 may include at least one processor 1100, a memory 1300, a user interface input device 1400, a user interface output device 1500, a storage 1600, and a network interface 1700 connected through a bus 1200.

The processor 1100 may be a central processing unit (CPU) or a semiconductor device that executes processing of commands stored in the memory 1300 and/or the storage 1600. The memory 1300 and the storage 1600 may include various types of volatile or non-volatile storage media. For example, the memory 1300 may include a read only memory (ROM) and a random access memory (RAM).

Therefore, operations of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM memory, a flash memory, a ROM memory, an EPROM memory, an EEPROM memory, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a user terminal. As yet another method, the processor and the storage medium may reside in the user terminal as individual components.

The above description is illustrative purpose only and various modifications and transformations become apparent to those skilled in the art within a scope of an essential characteristic of the present invention.

Accordingly, the embodiments disclosed herein are intended not to limit but to describe the technical spirit of the present invention, and the scope of the spirit of the present invention is not limited to the embodiments. The scope of the present invention should be interpreted by the appended claims and all technical spirit in the equivalent range is intended to be embraced by the appended claims of the present invention.

What is claimed is:

1. An antenna structure of a base station, comprising:
at least one beamforming antenna disposed to include an effective beam area having a first diameter and a non-overlapping beam area having a second diameter as a projection criterion of a bottom surface at a spot beam center of a spot beamby considering characteristics, performance, a base station coverage, and a height of the beamforming antenna, and disposed so that the second diameter is smaller than the first diameter by a designated size.

2. The antenna structure of claim 1, wherein the non-overlapping beam area includes an arc-shaped projection beam center circle which coincides with an arc center of the second diameter and the center of a base station antenna and a projection beam center circle having a width equivalent to a half the diameter of the non-overlapping beam area.

3. The antenna structure of claim 1, wherein an average effective projection beam area of the first diameter by the plurality of beamforming antennas and an average non-overlapping projection beam area of the second diameter by the plurality of beamforming antennas are formed.

4. The antenna structure of claim 1, wherein the beamforming antennas are designed to mechanically vertically or horizontally tilt the average effective projection beam area oriented through a base station phase reference beam center orientation angle and a base station phase reference beam width or designed to be beam-tilted through beam steering using electronic phase control.

5. The antenna structure of claim 1, wherein spot beams of the beamforming antennas are beam-tilted so as to guarantee the average non-overlapping beam area with a designated size or more.

6. The antenna structure of claim 1, wherein the beamforming antennas separate a plurality of beam component carriers defined by dividing a millimeter wave wideband into predetermined-unit frequencies into a plurality of groups and are disposed so that beams overlap with each other.

7. The antenna structure of claim 1, wherein beamforming antennas that take charge of one partition among the beamforming antennas divided into the plurality of groups are disposed by considering only a substantial projected effective beam area and in areas which the projected effective beam area is not capable of taking charge of, beamforming antennas that take charge of other partitions of the frequency are disposed to overlap with each other in an interleaving form.

8. The antenna structure of claim 1, wherein the beamforming antenna includes at least one of a patch array antenna and a horn antenna.

9. The antenna structure of claim 1, wherein the beamforming antennas support a macro cell function based on a grouped sector beam structure and serve as a small cell based on a spot beam structure.

10. An antenna structure of a terminal, comprising:
a plurality of patch array antennas grouped by a plurality of terminal phases,
wherein the plurality of patch array antennas is disposed on each of an upper end, a middle end, and a lower end.

11. The antenna structure of claim 10, wherein the patch array antennas are disposed to cover the circumference of a body surface along an actual body surface of the terminal.

12. The antenna structure of claim 10, further comprising:
patch array antennas disposed on the top of the upper end and the bottom of the lower end, respectively.

13. The antenna structure of claim 10, wherein in the patch array antennas, patch array antennas of the same number are disposed on each of the upper end, the middle end, the lower end in a plurality of directions.

14. An operation method of a terminal in which a plurality of patch array antennas is disposed on each of an upper end, a middle end, and a lower end, the operation method comprising:
an operation of measuring cell reference signals from a plurality of terminal phase ports corresponding to the patch array antennas, respectively and memorizing a port having a signal strength of a designated magnitude or more;
an operation of calculating average values of receiving ports corresponding to a designated signal level by considering the number of ports which is able to be soft-combined according to hardware performance and receiving ports corresponding to a signal levels or calculating the most excellent value among soft-combined signal receiving values; and
an operation of determining a link port to correspond to the calculation result.

15. The operation method of claim 14, further comprising:
a beam tracking operation comprising at least one of an operation of determining an uplink port through cell reference signal measurement for each port and an operation of performing movement among beam groups defined as cells by using combining and an average cell reference signal measurement value.

16. The operation method of claim 14, wherein:
the operation of determining the uplink port includes,
an operation of acquiring a cell reference signal receiving measurement value calculated to perform inter-cell handover, and
an operation of determining a port having a largest cell reference signal receiving measurement value for each port as a port for uplink transmission.

17. The operation method of claim 14, wherein:
the beam tracking operation includes at least one of
an operation of performing beam tracking in the same beam area,
an operation of performing the beam tracking on a beam boundary formed by two beamforming antennas adjacent to the same base station, and
an operation of performing the beam tracking on a boundary region of beams of two respective base stations.

18. The operation method of claim 17, wherein:
the operation of performing the beam tracking on the beam boundary includes,
an operation of selecting several ports in the order in which the cell reference signal measurement value is the larger, and
an operation of finding several beam reference signal measurement values input at a signal level which is able to be accepted again for each port at the selected port and selecting a port in which the largest beam reference signal measurement value is input as an uplink port.

19. The operation method of claim 17, wherein the operation of performing the beam tracking on the beam boundary includes an operation of determining multiple ports through the cell reference signal measurement value and determining an optimal port through beam signal reference signal measurement at the port again.

20. The operation method of claim 14, wherein the determining operation includes an operation of determining the optimal uplink beam port by the premeasured multiple beam reference signal measurements having the same cell for each effective port of the determined cell.

21. The operation method of claim 14, further comprising:
an operation of receiving base station system information comprising neighboring beam information for each beam and beam reference signal information for each cell in association with idle beam tracking.

22. An antenna structure of a base station using a millimeter wave, the antenna structure comprising:
a plurality of beamforming antennas,
wherein the plurality of beamforming antennas is formed by at least one layer comprising at least one of a spot beam structure and a sector beam structure based on at least one beam component carrier acquired by dividing a wideband of the millimeter wave into layers having a predetermined size.

23. The antenna structure of claim 22, wherein a frequency allocated to at least one beamforming antenna for the spot beam structure and a frequency allocated to at least one beamforming antenna for the sector beam structure are different from each other.

24. The antenna structure of claim 22, wherein the plurality of beamforming antennas is configured to operate a plurality of beam component carriers for each layer or operate one beam component carriers for each layer.

25. The antenna structure of claim 22, wherein:
the plurality of beamforming antennas is configured to
operate a predetermined number of grouped beam component carriers for each layer as each cell or
operate all beam component carriers of one layer as one cell.

26. The antenna structure of claim 22, wherein the plurality of beamforming antennas are configured to operate different numbers of cells for each layer.

27. The antenna structure of claim 22, wherein the plurality of beamforming antennas are configured to operate cells grouped by different numbers of beam component carrier cells for each layer.

28. The antenna structure of claim 22, wherein the plurality of beamforming antennas are configured to operate beam component carrier cells at different locations for each layer.

29. The antenna structure of claim 22, wherein the plurality of beamforming antennas are configured to operate a beamforming structure of a specific layer differently from a beamforming structure of another layer.

30. The antenna structure of claim 22, wherein the plurality of beamforming antennas are configured to operate at least one layer as a coverage layer and operate at least one residual layer as a capacitor layer.

31. The antenna structure of claim 22, wherein the plurality of beamforming antennas are configured to operate at least one active cell and at least one mute cell for each layer.

32. The antenna structure of claim 22, wherein the plurality of beamforming antennas are configured to turn off an entire layer without operation of the terminal under a designated condition and turn on the turned off layer when a data capacity is generated.

33. An operation method of a base station using a millimeter wave, the operation method comprising:
an operation of forming at least one of a spot beam structure and a sector beam structure in a multi-layer form based on at least one beam component carrier by using a plurality of beamforming antennas; and
an operation of supporting a coverage function of at least one terminal based on cells of a specific layer and supporting a capacity function of the terminal based on cells of residual layers.
